(19) United States
(12) Patent Application Publication
(10) Pub. No.: US 2004/0007527 A1
(43) Pub. Date: Jan. 15, 2004

(54) Membrane filtration device and process

(75) Inventors: Steven Kristian Pedersen, Burlington (CA); Pierre Lucien Cote, Dundas (CA); Arnold Janson, Burlington (CA); Hidayat Husain, Brampton (CA); Manwinder Singh, Burlington (CA); Nicholas Adams, Hamilton (CA); Jason Cadera, Guelph (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Zenon Environmental Inc., Oakville (CA)

(21) Appl. No.: 10/440,267

(22) Filed: May 19, 2003

Related U.S. Application Data
(63) Continuation-in-part of application No. 10/098,365, filed on Mar. 18, 2002.
(63) Continuation-in-part of application No. 09/889,352, filed on Jul. 17, 2001.
(63) Continuation-in-part of application No. 09/889,351, filed on Jul. 17, 2001.
(63) Continuation-in-part of application No. 09/565,032, filed on May 5, 2000.
Application No. PCT/CA00/01359 is a continuation-in-part of application No. 09/565,032, filed on May 5, 2000.
Application No. PCT/CA00/01359 is a continuation-in-part of application No. 09/505,718, filed on Feb. 17, 2000, now Pat. No. 6,325,928.
Application No. PCT/CA00/01354 is a continuation-in-part of application No. 09/565,032, filed on May 5, 2000.
Application No. PCT/CA00/01354 is a continuation-in-part of application No. 09/505,718, filed on Feb. 17, 2000, now Pat. No. 6,325,928.
(60) Provisional application No. 60/109,520, filed on Nov. 23, 1998.

(30) Foreign Application Priority Data
Nov. 18, 1999 (CA) 2,290,053
May 5, 2002 (CA) 2,308,230

(51) Int. Cl. B01D 61/00; B01D 63/00

(52) U.S. Cl. 210/650; 210/636; 210/321.8; 210/321.89

(57) ABSTRACT

An element for use in ultrafiltration or microfiltration of potable water has a large number of small diameter hollow fibre membranes attached between two headers. Side plates attached to the sides of the headers define vertical flow channels containing the membranes. The elements may be placed side by side and stacked on top of each other to form cassettes having continuous vertical flow channels through the entire cassette. The membrane modules or cassettes may be arranged to cover a substantial part of the cross sectional area of an open tank. Tank water may flow upwards or downwards through the flow channels. A tank may be deconcentrated by at least partially emptying and refilling the tank with fresh water while permeation continues. Excess tank water created during deconcentration may flow generally upwards through the modules and out through a retentate outlet or overflow at the top of the tank.

This application is a continuation-in-part of U.S. patent application Ser. No. 10/098,365, filed Mar. 18, 2002; Ser. No. 09/889,352, filed Jul. 17, 2001; Ser. No. 09/889,351, filed Jul. 17, 2001; and, 09/565,032, filed May 5, 2000; wherein, U.S. patent application Ser. No. 10/098,365 is a division of U.S. patent application Ser. No. 09/444,414, filed Nov. 22, 1999 and issued as U.S. Pat. No. 6,375,848, which is a non-provisional of provisional application No. 60/109,520, filed Nov. 23, 1998; U.S. patent application Ser. No. 09/889,352 is a 371 of PCT/CA00/01359, filed Nov. 15, 2000, and a continuation-in-part of U.S. patent application Ser. No. 09/565,032, filed on May 5, 2000 and a continuation of U.S. patent application Ser. No. 09/505,718, filed on Feb. 17, 2000; U.S. patent application Ser. No. 09/889,351 is a 371 of PCT/CA00/01354, filed Nov. 15, 2000, and a continuation-in-part of 09/565,032, filed on May 5, 2000, and a continuation-in-part of 09/505,718, filed Feb. 17, 2000. The entire text and figures of all of the patents and applications listed above and Canadian Application Nos. CA2,290,053 filed Nov. 18, 1999, CA2,308,230 filed May 5, 2000 and PCT Application No. PCT/CA99/01113 filed Nov. 18, 1999 are hereby incorporated by this reference to them as if they were each fully set forth herein.

### FIELD OF THE INVENTION

This invention relates to a module or element of hollow fibre filtering membranes of the type normally immersed in a tank and used to withdraw a filtered permeate by means of suction applied to the lumens of the membranes and to the design and operation of a reactor using modules of immersed membranes to treat water.

### BACKGROUND OF THE INVENTION

Early membrane filtration technology focused on providing hollow fibre membranes in small cartridges or shells. Feed water was typically introduced into the shells at high pressure thus driving permeate through the membranes. The high pressure allows a small number of membranes to be used to achieve a desired rate of permeate production. The small volume of the shells and the presence of high pressure pumps in the system allows the membranes to be cleaned vigorously by flowing feed at high speed across the surface of the membranes and by high pressure gas backwashing.

While development of shelled systems continues, the inventors herein and others developed a shell-less module which they described in U.S. Pat. No. 5,248,424 which issued on Sep. 28, 1993 to Zenon Environmental Inc. In this module, hollow fibre membranes are held in fluid communication with a pair of spaced headers to form modules in a variety of configurations. The modules are unconfined in a solid modular shell and immersed in a comparatively large open tank. Transmembrane pressure (“TMP”) is provided by suction on the lumens of the fibres. The membranes are mounted in the modules such that they move under the influence of air bubbles provided from below the membranes. The rising air bubbles physically clean the membranes on contact and also create a circulation pattern in the tank water which removes solids rich water from the membrane module and replaces it with fresh feed water.

Subsequently, further shell-less membrane modules appeared with hollow fibre membranes in both substantially vertical and substantially horizontal orientations. Shell-less modules with membranes oriented vertically are shown in U.S. Pat. No. 5,639,373 issued to Zenon Environmental Inc. on Jun. 17, 1997; U.S. Pat. No. 5,783,083 issued to Zenon Environmental Inc. on Jul. 21, 1998 and PCT Publication No. WO 98/28066 filed on Dec. 18, 1997 by Memtec America Corporation. In these modules, headers are spaced vertically only.

Shell-less modules with membranes oriented horizontally are described in U.S. Pat. No. 5,480,553 issued to Mitsubishi Rayon Co., Ltd on Jan. 2, 1996; Japanese Published Applications JP-07024272, JP-07178321, JP 07275665 and JP-09215980 filed on Jan. 27, 1995, Jul. 18, 1995, Oct. 24, 1995 and Aug. 19, 1997 respectively by Mitsubishi Rayon Co., Ltd and in an article, “Development of a tank-submerged type membrane filtration system”, by K. Suda et. al. of Ebara Corporation published in Desalination 119 (1998) 151-158.

Despite the proliferation of membrane module designs, membrane filtration technology has not achieved wide acceptance. For example, despite the improved quality of water filtered through membranes, sand filters are still used more often, largely because of their much lower cost. For example, the performance of a shell-less module with horizontal membranes was tested by Ebara Corporation and the results reported in the article mentioned above. While the authors were able to achieve stable operation over extended periods of time, the tank superficial velocity (the flux of permeate, typically in m³/h, divided by the tank footprint, typically in m²) was only about 1.7 m/h. In comparison, a typical sand filtration system has a tank superficial velocity of 5-10 m/h allowing for the use of much smaller tanks—a significant cost in a large municipal or industrial system.

Immersed membranes are used for separating a permeate lean in solids from tank water rich in solids. Feed water flowing into a tank containing immersed membranes has an initial concentration of solids. Filtered permeate passes through the walls of the membranes under the influence of a transmembrane pressure differential between a retentate side of the membranes and a permeate side of the membranes. As filtered water is permeated through the membranes and removed from the system, the solids are rejected and accumulate in the tank. These solids must be removed from the tank in order to prevent rapid fouling of the membranes which occurs when the membranes are operated in water containing a high concentration of solids.

In a continuous fully mixed process, there is typically a continuous bleed of tank water rich in solids, which may be called retentate. Unfortunately, while this process preserves a mass balance, the tank water must contain an elevated concentration of pollutants or the process will generate large volumes of retentate.

Another process involves filtering in a batch mode in which retentate is not withdrawn continuously. Instead, the tank water is drained to remove the accumulated solids from time to time. The tank is then refilled with fresh feed water and operation continues. While regular operation is interrupted in this method, there is a period directly after the tank is refilled in which the membranes are operated in relatively solids lean tank water. For feed water with low suspended solids, the intervals between drainings may be long enough that the benefit gained by emptying the tank offsets the loss in production time.

With either process, as filtered water is permeated through the membranes the solids in the tank water foul the membranes. The solids may be present in the feed water in a variety of forms which contribute to fouling in different ways. To counter the different types of fouling, many different types of cleaning regimens may be required. Such cleaning usually includes both physical cleaning and chemical cleaning.

The most frequently used methods of physical cleaning are backwashing and aeration. These methods are typically performed frequently and thus may influence the filtering process. In backwashing, permeation through the membranes is stopped momentarily. Air or water flow through the membranes in a reverse direction to physically push solids off of the membranes. In aeration, bubbles are produced in the tank water below the membranes. As the bubbles rise, they agitate or scrub the membranes and thereby remove some solids while creating an air lift effect and circulation of the tank water to carry the solids away from the membranes.

Chemical cleaning is typically performed less frequently than backwashing or aeration. According to one class of methods, permeation is stopped and a chemical cleaner is backwashed through the membranes. In some cases, the tank is emptied during or after the cleaning event so that the chemical cleaner can be collected and disposed of. In other cases, the tank remains filled and the amount of chemical cleaner in a cleaning event is limited to an amount that is tolerable for the application.

The cleaning methods all damage the membranes over time. In addition, backwashing with permeate or chemical cleaner interrupts permeation and reduces the yield of the process. Aeration requires energy which adds to the operating costs of a reactor and the resulting circulation of tank water requires significant open space in the tank. Processes that involve frequently draining the tank require less cleaning in some cases. Particularly in large systems, however, loss in production time can be high because it is difficult to drain a large municipal or industrial tank quickly.

### SUMMARY OF THE INVENTION

It is an object of the present invention to improve on the prior art. It is another object of the present invention to provide a normally immersed element or module of suction driven filtering membranes. It is another object of the present invention to provide a system or reactor using an immersed membrane module. It is another object of the present invention to provide a process which uses immersed filtering membranes as part of a process of treating water. These objects are met by the combination of features, steps or both found in the independent claims, the dependent claims disclosing further advantageous embodiments of the invention. The following summary may not describe all necessary features of the invention which may reside in a sub-combination of the following features or in a combination with features described in other parts of this document.

In one aspect, the invention is directed at a membrane module having two opposed vertically extending headers. A large number of small diameter hollow fibre membranes which may have no substrate are attached in a slightly slackened state between two rectangular solid headers but in fluid communication with only one of the headers which has a permeate conduit. The membranes are generally horizontal but may slant slightly upwards towards the header with the permeate channel. Side plates attached to the sides of the headers and extending between them protect and contain the membranes while defining vertical flow channels containing the membranes. The membranes may have a packing density of about 15% to 25%. The header having the permeate channel is capped at its upper end with a T connector and has a recess at its lower end to admit a T connector from a header below it. The headers, membranes, side panels and T connectors define membrane elements which may be placed side by side with other elements units to create membrane modules which can be stacked on top of each other to form membrane cassettes of various sizes having continuous vertical flow channels through the entire cassette. In operation, permeate flux may be between 10 and 60 L/m²/h. Aeration may be provided in the absence of permeation directly before, directly after or during backwash at a superficial velocity (m³/h of air at standard conditions per m² of module cross-sectional area) of 80 m/h to 340 m/h and during permeation at 0.0 m/h to 80 m/h or intermittently.

In another aspect, the invention is directed at a method of manufacturing a membrane module as described above. Headers in the shape of a rectangular solid are moulded of a suitable plastic with an inner recess defining a permeate channel. A heater is placed in a lower portion of the recess and covered with solidified wax. A suitable number of fibres are gathered in a bundle without attempting to arrange the fibres in a grid or matrix. The bundle of fibres is dipped in a pool of liquid wax maintained at a temperature such that the wax freezes seconds after the bundle of fibres are removed to prevent excessive wicking. The wax seals the ends of the fibres, surrounds the fibres and holds them in a closely spaced apart relationship. The waxed fibre bundle is then inserted into the recess of the header. Potting resin is poured into the header to cover the fibre bundle to a depth greater than the distance that the wax wicked up the fibres. The electric heater is turned on to liquify the wax so that it flows out leaving a clear permeate channel in communication with the lumens of the membranes.

In another aspect, the invention is directed at a reactor in which the membrane modules or cassettes are arranged in an open tank to cover a substantial part of the horizontal cross sectional area of the tank, preferably 80% or 90% or more. The upper perimeters of the modules or cassettes are surrounded by a casing to enclose a volume directly above the module. In one embodiment, the casing is provided with a retentate outlet from the tank. Feed water is added to the tank to maintain a normal level of tank water above the retentate outlet. Thus, tank water is forced upwards through the vertical flow channels. Tank water that is not withdrawn as permeate flows out of the tank through the retentate outlets. The supply of feed is controlled to provide a selected flow out of the retentate outlet. In another embodiment, the tank is provided with a retentate outlet and feed water is added to directly to the casing and tank water flows downwards through the vertical flow channels.

In another aspect, the invention provides a process for filtering water using membranes immersed in an open tank. The process includes reducing the concentration of solids in the water in the tank from time to time through deconcentrations. The deconcentrations are performed by withdrawing retentate rich in solids and simultaneously replacing it with a similar volume of feed water such that the membranes remain immersed during the deconcentration and permeation is not interrupted. The volume of retentate removed in a deconcentration is between 40% and 300% of the volume of water normally in the tank. At the end of a deconcentration, the water in the tank has 40% or less of the average concentration of solids in the tank before the deconcentration. One or more of aeration or backwashing may be biased towards a later part of a period between deconcentrations.

In another aspect, the invention provides an open tank divided into a plurality of sequential filtration zones. Partitions between the filtration zones substantially prevent mixing between the filtration zones but for permitting water containing solids to flow from the first filtration zone to the last filtration zone through the filtration zones in sequence. One or more membrane modules are placed in each filtration zone and a similar permeate flux is withdrawn from each filtration zone. A non-porous casing around the one or more membrane modules in each filtration zone provides a vertical flow channel through the one or more membrane modules. Tank water flows downwards through the one or more membrane modules in each filtration zone. A plurality of passages connect the bottom of the vertical flow channel in one filtration zone to the top of the vertical flow channel of another filtration zone and permit the tank water to flow from the first filtration zone to the last filtration zone through the filtration zones consecutively. The passages may include a weir at the tops of the partitions. Packing density, aeration and backwashing are biased towards an outlet end of the tank. The tank may be deconcentrated from time to time as described above. Alternatively, the last filtration zone may be deconcentrated by draining and refilling it while permeation from the last filtration zone is stopped.

In another aspect, the invention is directed at an element having hollow fibre membranes attached to and suspended between a pair of opposed horizontally spaced, vertically extending headers. Side plates extending between the pair of vertically extending headers define a vertical flow channel through the element. The hollow fibre membranes are arranged in bundles which, when dispersed, fill a central portion of the vertical flow channel. One header of the pair of headers may have a permeate channel and the hollow fibre membranes may be fixedly attached to the other header.

A module of filtering hollow fibre membranes using the elements described above is made by arranging such elements side by side or in an orthogonal grid such that the side plates and headers of the elements form a plurality of directly adjacent vertical flow channels. A frame restrains the elements in place without obstructing the vertical flow channels. The restraint provided by the frame may be released for a selected element, however, allowing the selected element to be removed or replaced in a direction substantially normal to its headers without disassembling the remainder of the module. Each element has an associated releasable and resealable water tight fitting between the element and a permeate collector, the releasable water tight fitting being released when the element is removed from the module. An aerator below the module has a plurality of air holes located to provide a line of air holes below each flow channel or below a side plate between each pair of flow channels.

In another aspect, the invention is directed at a process for filtering water using such elements or modules. In the process, permeate flux is less than 60 L/m²/h and aeration to scrub the membranes is provided when permeation is periodically stopped. A tank containing the elements or modules is emptied and refilled from time to time to remove accumulated solids. Gentler aeration may be provided during permeation to homogenize the contents of the tank. Elements having a membrane surface area of at least 500 m² for every cubic metre of element volume may be used and placed in the tank to provide at least 400 m² or 500 m² of membrane surface area per square metre of tank footprint.

In another aspect the invention provides, a filtration system having immersed suction driven filtering membranes used to filter water containing low concentrations of suspended solids, for example, to filter surface water to produce potable water. Membrane modules are arranged in a tank open to the atmosphere and fill most of its horizontal cross sectional area. An upper portion of the tank encloses a volume directly above the modules. This upper portion of the tank is provided with a retentate outlet from the tank. Tank water that is not withdrawn as permeate flows out of the tank through the retentate outlet. Permeate is withdrawn by suction on an inner surface of the membranes, for example at a flux between 10 and 60 L/m²/h. Feed water is added to the tank at a rate that substantially equals the rate at which permeate is withdrawn. Thus during permeation little if any tank water flows out of the outlet and the level of the tank water remains above the membranes. Permeation is stopped periodically for a deconcentration step. During the deconcentration step the membranes are backwashed, feed flow is provided from below the modules or both. Tank water rises through the modules, the water level in the tank rises and tank water containing solids (then called retentate) flows out of the retentate outlet to deconcentrate the tank water. Aeration with scouring bubbles may be provided during the deconcentration step.

In other aspects of the invention, one or more of the aspects described above may be combined together in various combinations.

### BRIEF DESCRIPTION OF THE DRAWINGS

Preferred embodiments of the present invention will now be described with reference to the following figures.

FIGS. 1A and 1B are elevation and plan views of a filtering element respectively.

FIG. 1C is an isometric view of a portion of a filtering element.

FIG. 2 is an isometric view of a module made of the elements in FIGS. 1A, 1B and 1C.

FIG. 3 is an isometric view of a sub-module aerator.

FIG. 4A is an isometric view of a cassette made of the modules of FIG. 2.

FIG. 4B is an isometric view of an assembly of 6 of the cassettes of FIG. 4A.

FIGS. 5A and 5B are representations of steps in the manufacture of the element of FIGS. 1A and 1B.

FIGS. 6 and 7 are schematic representations of filtering reactors.

FIG. 8 is a schematic representation of another immersed membrane reactor.

FIGS. 9, 10 and 11 are representations of various membrane modules.

FIG. 12 is an elevation view of membrane modules of FIG. 11 adapted for use with a filtering reactor having membrane modules in series.

FIG. 13 is a plan view of the membrane modules of FIG. 12.

FIG. 14 is a schematic representation of a filtering reactor having membrane modules in series.

FIGS. 15 and 16 show tanks with alternate shapes.

FIG. 17 is a plan view of a filtering element.

FIG. 18 is an elevation view of the filtering element of FIG. 17.

FIG. 19 is an isometric view of the filtering element of FIG. 17 (but without membranes).

FIG. 20 is a sectional view of a permeate fitting for use with the element of FIGS. 17 through 19.

FIG. 21 is an isometric view of a module of the elements of FIGS. 17 through 19 from the back.

FIG. 22 is an isometric view of a module of FIG. 21 from the front.

FIG. 23 is an enlarged view of a portion of the module of FIG. 22.

FIG. 24 is an isometric view of a sub-module aerator.

FIG. 26 is a schematic representation of a filtering reactor made in accordance with a preferred embodiment of the present invention.

FIG. 27 is a plan view of a filtering reactor made in accordance with a preferred embodiment of the present invention.

### DETAILED DESCRIPTION OF EMBODIMENTS

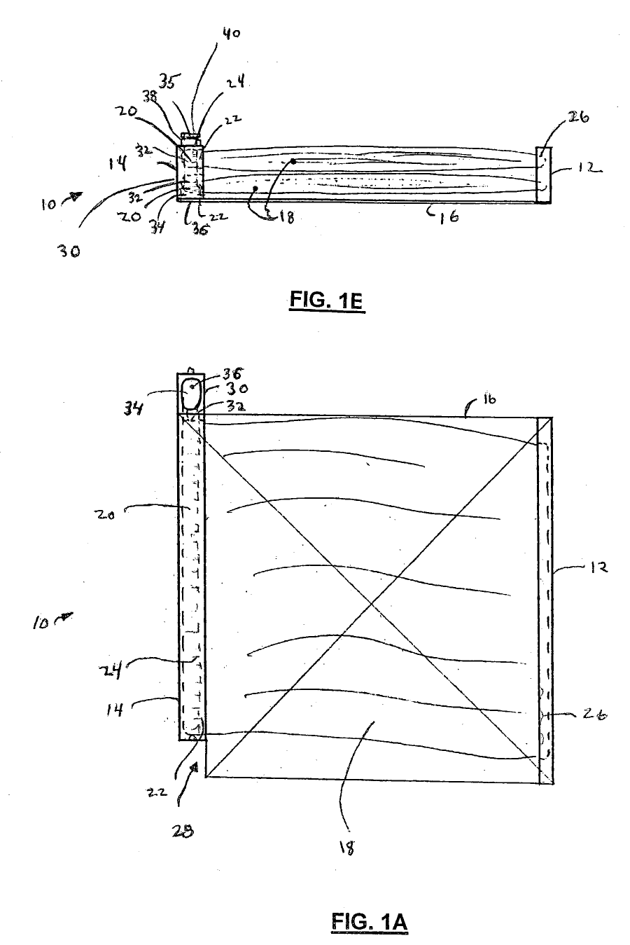

Referring now to FIGS. 1A and 1B, a filtering element 10 is shown in elevation and plan views respectively. The element 10 has a closed header 12 and an open header 14 held in horizontally spaced relationship by a side plate 16. Preferably, the closed header 12 and an open header 14 are rectangular solids (but for cavities etc.) and the side plate 16 is attached to the closed header 12 and open header 14 by snap fittings, screws or glue. A plurality of hollow fibre membranes 18 are attached between the closed header 12 and the open header 14, the lumens of the membranes 18 in fluid communication with one of two permeate channels 20 in the open header 14. The membranes 18 are held in a closely spaced apart relationship in a plug of potting resin 22 which encloses the permeate channels 20 of the open header 14. The resin 22 surrounds each membrane 18 so that water cannot enter the permeate channel 20 other than by passing through the walls of the membranes 18. The membranes 18 have a pore size in the microfiltration or ultrafiltration range, preferably between 0.003 and 10 microns and more preferably between 0.01 and 1.0 microns.

The membranes 18 may each be a distinct fibre having an open end and a closed end but preferably the membranes 18 are made of looped fibres having open ends 24 in fluid communication with a permeate channel 20 of the open header 14 and looped ends 26 connected to the closed header 12. The membranes 18 are unsupported internally (i.e. by a substrate) or externally (i.e. by transverse fibres) and can be made, for example, of cellulose acetate, polypropylene, polyethelene, polysulfone and preferably of a complex of PVDF and calcined .alpha.-alumina particles as described in U.S. Pat. No. 5,914,039, incorporated by this reference. In order to produce a large surface area, the membranes 18 have small outside diameters in the range of 0.2 mm to 1.0 mm. With such small diameter membranes 18, head loss in the lumen of the membranes 18 is significant and preferred effective lengths of fibre are short—between 0.2 m for smaller diameter fibres to 1.0 m for larger fibres. The effective length is defined as the maximum distance between an un potted point on the membranes 18 and the proximal face of the open header 14 and, accordingly, each loop of a membrane 18 is approximately twice the effective length plus length required for potting. With membranes 18 as described above, the tensile strength of the membranes 18 is low and the forces applied to the membranes 18 by aeration are a concern. By arranging the membranes 18 as loops with their looped ends 26 secured in the closed header 12, the unsupported length of the membranes, and thus the maximum forces on the membranes 18 from aeration, are reduced in half compared to the usual configuration wherein horizontal membranes are suspended between two permeating headers. The membranes 18 do not need to be sealingly secured to the closed header 12 but are fixedly attached so that tensile forces in the membranes 18 are transferred to the closed header 12. As an example, membranes 18 made of complex of PVDF and calcined alpha. alumina particles, as mentioned above, with an outside diameter of 0.6 mm and an inside diameter of 0.35 mm are suitable for an element 10 in which the proximal faces of the closed header 12 and the open header 14 are spaced between 610 and 615 mm apart. The length of the membranes 18, however, is slightly longer than the distance between the proximal faces of the closed header 12 and the open header 14 as will be explained below.

The membranes 18 are mounted so as to have between 0.1% and 5% slack and so as to be slanted slightly upwards towards the open header at about 5 degrees as measured along a line from their looped ends 26 to their open ends 24. The slackness of the membranes 18 allows them to vibrate or sway under the influence of scouring bubbles which aids in inhibiting their fouling. The angle of the membranes 18 assists in withdrawing air from the looped ends 26 of the membranes 18 when a new module is first used after manufacture or some maintenance procedures. Combining the slackness of the membranes 18 and their upwards angle may result in the membranes 18 sloping downwardly near their open ends 24, but air in the lumens of this part of the membranes 18 generally leaves the membranes 18 shortly after a transmembrane force is applied to the membranes 18.

The open header 14 and closed header 12 are injection moulded from a suitable plastic such as PE, PP, polyester or polycarbonate. The open header 14 is less than 1 m in length which is more convenient for injection moulding and allows various numbers of elements 10 to be stacked on top of each other to fill tanks of varying depths. The closed header 12 is shorter by the length of a recess 28 sized to fit a permeate fitting 30 of a lower element 10. The open header 14 preferably has two permeate channels 20 each between 30 mm and 40 mm wide which provides a manageable size for the potting method which will be described below. Each bundle of membranes 18 is between 20 and 30 mm wide which allows water and aeration to penetrate the bundle. For example, an element 10 having a closed header 12 that is 700 mm long, an open header 14 that is 100 mm wide and having two permeate channels about 35 mm wide and about 600 mm long can be built with approximately 31 000 membranes 18 of 0.6 mm outside diameter in two bundles about 25 mm wide for a total surface area of approximately 36 m². At a flux of 30 L/m²/h for example, the membrane module 10 would produce about 1.1 m3/h of permeate.

The permeate fitting 30 is connected to the permeate channels 20 by a permeate opening 32 at the top of the open header 14. The permeate fitting 30 is a rectangular solid (but for cavities etc.) having width similar to and depth similar or greater than the open header 14 so as to cover the top end of the open header 14. The permeate fitting 30 may be attached to the open header 14 by a removable water tight fitting but is preferably glued or ultrasonically welded to the open header 14. The permeate fitting 30 has a permeate cavity 34 within it connecting the permeate channel 20 with a side opening 36 on either side of the permeate fitting 30.

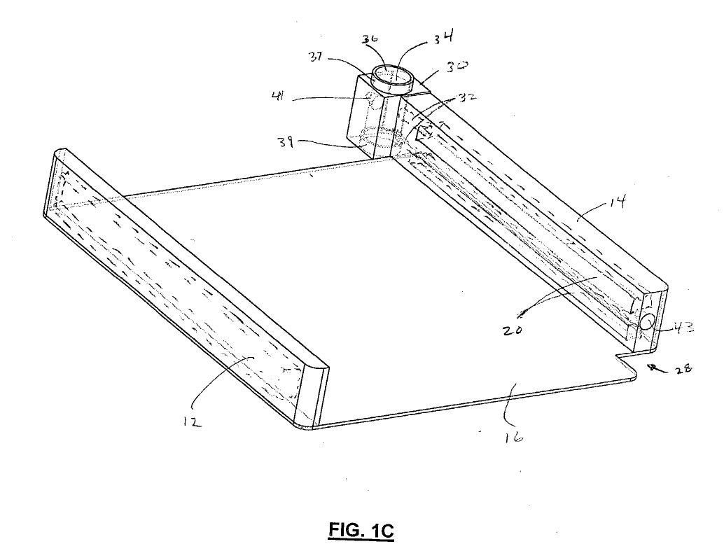

Referring to FIGS. 1A, 1B, 1C and 2, a plurality of elements 10 are attached side by side to create a module 50. The width of the module 50 can be any convenient multiple, typically six to twelve, of the width of the elements 10. Preferably, the multiple is chosen to maximize the number of elements 10 that can be placed in a tank of a given size.

The permeate cavities 34 of adjacent permeate fittings 30 provide a continuous permeate header 52. Adjacent permeate cavities 34 can be attached to each other by gluing or ultrasonically welding them to produce a watertight assembly. In this case, the width of the permeate fittings 30 needs to account for the side plates 16. As shown in FIG. 1C, area for gluing or ultrasonic welding is increased with a ring 37 and corresponding recess 39. Alternately, and preferably if disassembly is anticipated, a male part 38 having a sealing member 40, typically a rubber O-ring, can be inserted into a mating side opening 36 of an adjacent element 10 as shown in FIGS. 1A and 1B. A permeate fitting 55 to collect permeate as required can be attached to both ends of the permeate header 52 but is more typically attached to only one side, the other side being sealed with a cap 54. Referring to FIGS. 1C and 2, knobs 41 and corresponding indents 43 help align modules 50 when stacked on top of each other as will be described below.

Referring to FIG. 2, when the elements 10 are attached side-by-side, the side plates 16 of adjacent elements 10 define vertical flow channels 56 containing the membranes 18. The last element 10 has an additional side plate 16 to define a flow channel 56 in it. The width of the flow channels 56 is such that the membranes 18 move sideways enough to substantially fill a central portion of the flow channels 56, the central portion preferably being between a third and two thirds of the distance between the proximal faces of the open header 14 and closed header 12. The reduced length of the membranes 18, compared to a design in which permeate is withdrawn from both ends of the membranes 18, tends to reduce tangling of the membranes 18 and reduces the width of the flow channel 16 allowing more compact elements 10. The side plates 16 also protect the membranes 18 from damage during shipping, installation or maintenance and temporary side plates 16 are used as necessary when elements 10 or sections of modules 50 are handled.

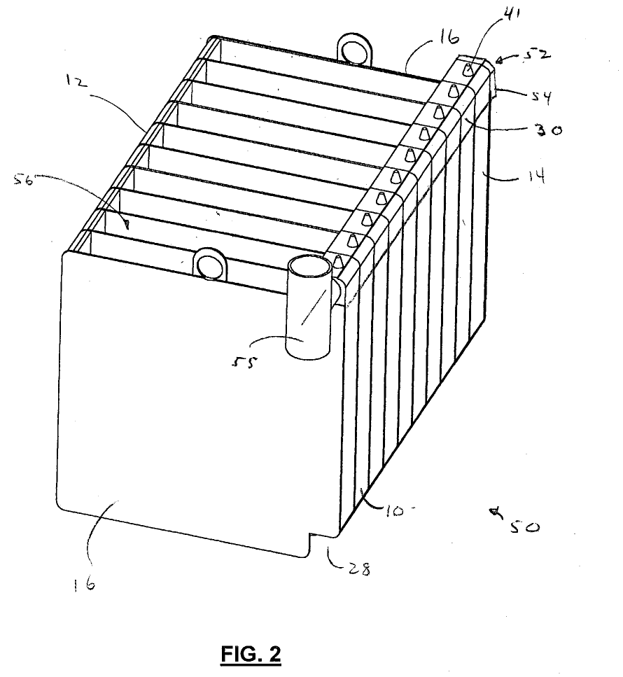

Referring now to FIG. 3, a sub-module aerator 60 is shown having a header 62 connected to a series of parallel conduit aerators 64 having holes 66 to produce scouring air bubbles. The spacing between the conduit aerators 64 is preferably the same as the width of the elements 10. Alternately, the conduit aerators 64 can be placed perpendicular to the elements 10 and the holes 66 spaced apart by the width of the elements 10. In this way, the sub-module aerator 60 can be installed to provide a source of air bubbles directly below the flow channel 56 of each element 10. Such an arrangement promotes a controlled amount of aeration being provided to each element 10 and minimizes air flow channelling which can starve membranes 10 of air, particularly when aeration rates are low. If required, a conduit aerator 64, or a hole 66 in a conduit aerator 64 perpendicular to the elements 10, can be provided directly below the side plate 16 between each pair of elements 10 to similar effect, although the first arrangement described is preferred.

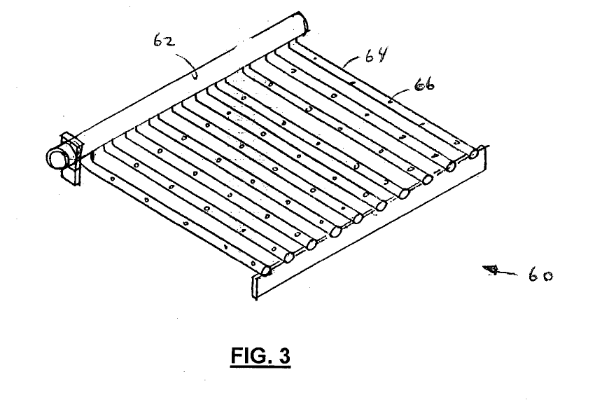

Referring to FIG. 4A, a cassette 80 has three modules 50 stacked on top of each other such that their flow channels 56 align. Cassettes 80 can also be made with various other numbers and arrangements of modules 50. The modules 50 are held together in a sub frame 82. Referring to FIG. 4B, groups of three cassettes 80 are made into an assembly 84 by connecting their sub-frames 82 to produce a full frame 86. Assemblies 84 can be made with various other numbers and arrangements of cassettes. The cassettes 80 are each provided with a bar 88 and hook 90 to facilitate installation and removal of an assembly 84. Pairs of assemblies 84 are preferably installed with their associated permeate fittings 55 occupying a common central space 92. The permeate fittings 55 from each cassette 80 are connected to form permeate collectors 94 extending upwards through the central space 92.

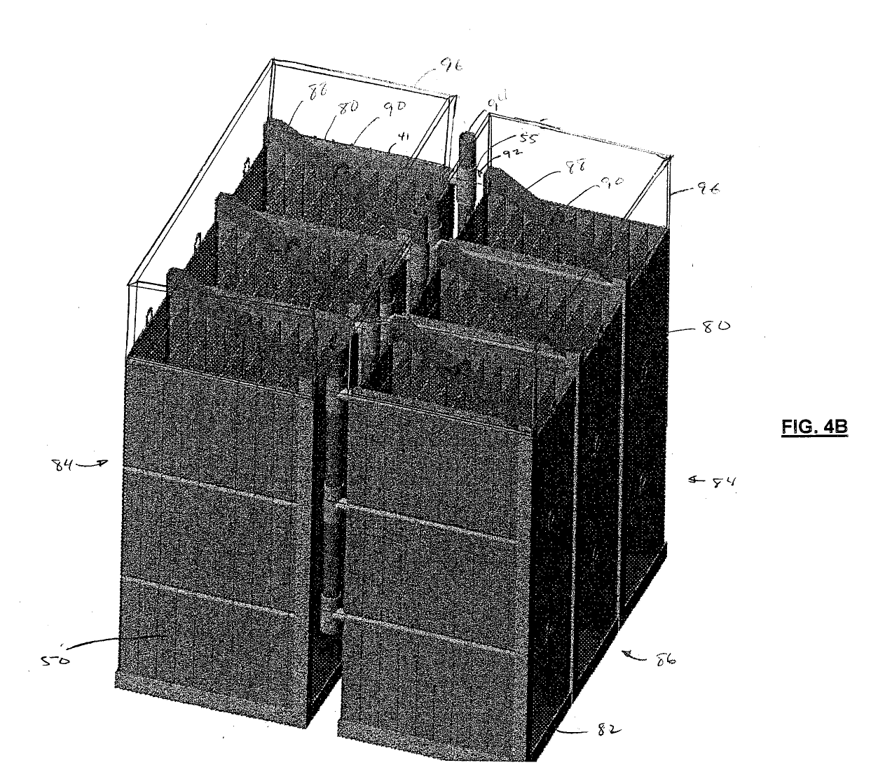

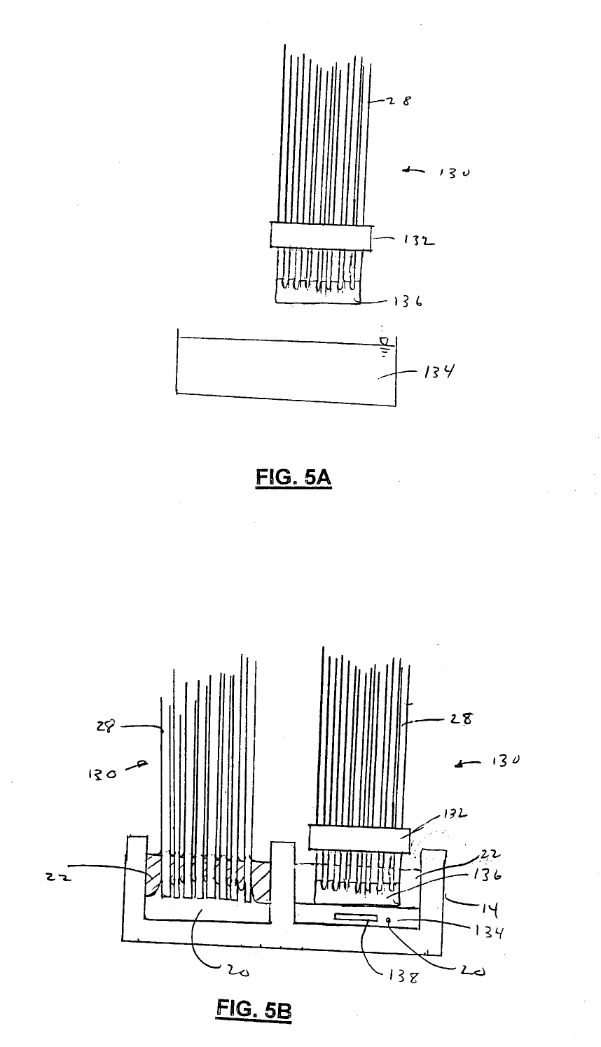

Referring to FIGS. 4A and 4B, a casing 96 is fitted over the top of a cassette 80 or assembly 84 to provided a volume above and in fluid communication with the flow channels 56. Alternately, as shown in FIGS. 6 and 7, a casing 96 is fitted over a plurality of assemblies 84 to provide a common volume above them and the central spaces 92 are separated from the volume by plates 98 fitted around the permeate fittings 55 or permeate collectors 94 as required to prevent significant amounts of water from flowing into the central space 92 when the casing 96 is full of water.

Referring now to FIGS. 6 and 7, assemblies 84 rest on stands 98 on the floor of a tank 100. Preferably, the assemblies 84 are sized and positioned to fill as much of the tank 100 as is practicable leaving room for necessary fittings and other apparatus and maintenance or set-up procedures but not for downcomers. Preferably, 80% or more of the horizontal cross-sectional area of the tank 100 is filled with assemblies 84. Such assemblies 84 can provide 700-800 m² of surface area of membranes 18 for each m² of footprint or horizontal cross sectional area of tank 100 resulting in a superficial tank velocity at a flux of 30 L/m²/h of over 20 m/h.

Referring still to FIGS. 6 and 7, the stands 98 support sub module aerators 60 in position relative to the flow channels 56 as described above. The headers 62 of the sub-module aerators 60 are connected to air supply pipes 102 in turn connected to an air supply 104. The permeate collectors 94 are connected to a permeate header 106 in turn connected to a permeate pump 108 and permeate outlet 110 with permeate valves 112. To facilitate backwashing, a permeate storage valve 114 is opened from time to time to fill a permeate storage tank 116. Stored permeate can then be used to backwash the assemblies 84 by closing permeate valves 112 and opening a pair of backwashing valves 120 in a backwash line 118. Permeate pump 108 is then operated to flow permeate from the permeate storage tank 116 in a reverse direction through permeate collectors 94 and the assemblies 84.

Referring now to FIG. 6, the casing 96 is provided with an outlet 120 connected to a drain 122. Feed water 124 is drawn from a feed supply 126 by a feed pump 128 and enters the tank 100 through an inlet 130 between the perimeter of the casing 96 and the wall of the tank 100. Feed water 124 enters the tank, wherein it will be called tank water 132, flows downward around the casing 96 and assemblies 84 to the bottom of the tank 100 and upwards through the flow channels 56. Tank water 132 which is not removed as permeate continues to flow upwards to the volume of the casing 96 from which it leaves the tank 100 through the outlet 120.

Referring to FIG. 7 an alternate arrangement is shown. A second tank 200 is provided with an outlet 120 connected to a drain 122. Feed water 124 enters the second tank 200 through a second inlet 230 inside or directly above a second casing 196. Feed water 124 enters the second tank 200, wherein it will be called tank water 132, flows downward through the flow channels 56. Tank water 132 which is not removed as permeate reaches the bottom of the second tank 200 and flows upwards past the assemblies 84 and second casing 196 and leaves the second tank 200 through the outlet 120.

In both FIGS. 6 and 7, the tank water 132 flowing in the flow channels 56 has a significant effect in preventing a build-up of solids in the assemblies 84 and thus substantially replaces the need for aeration to circulate tank water 132. Aeration is still provided, however, to scour the membranes 18 which is accomplished even when bubbles rise counter to a flow of tank water 132. Further, if permeate flux is kept below about 35 L/m²/h, the inventors have found that surprising little fouling occurs and gentler aeration is sufficient. More surprisingly, the energy cost savings produced by operating at low flux and low aeration more than offsets the cost of providing a large membrane surface area in the form of the elements 10 and modules 50 described above. The inventors believe that the horizontal orientation of the membranes 18, providing a source of air bubbles directly below one or two flow channels 56, the distribution of membranes 18 in the flow channels 56 and the flow of tank water 132 through the flow channels 56 assists in reducing the amount of aeration required. If foam is still produced by the limited aeration, the outlet 120 is preferably a weir which allows the foam to flow out of the tank 100 or second tank 200.

Preferably, the most strenuous aeration is provided during a period when permeation is stopped directly before, directly after or during a backwash. At this time, the aeration does not need to overcome suction on the membranes 18 to dislodge solids from the membranes 18 and aeration is provided at a superficial velocity (m³/h of air at standard conditions per m² of module cross-sectional area) between 80 m/h and 340 m/h. Such aeration inhibits fouling of the membranes 18. Aeration may also be provided at other times at the same rate for feed water containing solids which foul the membranes 18 rapidly. For many if not most feed waters, however, aeration to inhibit fouling is not required at other times. Such feed waters typically have low turbidity and solids concentrations less than about 500 mg/L. For filtering these feed waters, a smaller amount of aeration is advantageously provided during permeation to disperse solids form dead zones in a cassette 80. For this purpose, aeration is provided at a superficial velocity between 0.0 m/h to 80 m/h or intermittently at the higher rates described above.

Referring still to FIGS. 6 and 7, a process may be operated with tank water 120 substantially continually flowing out of the outlet 120, feed water 124 substantially continually entering the tank 100 or second tank 200 and permeate substantially continuously withdrawn from the tank 100 or second tank 200. The amount of permeate leaving the tank 100 or second tank 200 as a percentage of the feed water 124 entering the tank 100 or second tank 200 is referred to as a recovery rate and is preferably 90% or more and more preferably 95% or more when the tank water 132 leaving the tank 100 or second tank 200 will not be filtered further. Based on a selected permeate flux and recovery rate, the required flow of feed water 124 can be calculated. The feed pump 128 is then operated by a controller 142 to deliver the required flow. Alternatively, if a gravity feed is desired, feed pump 128 can be replaced by a valve similarly controlled. Outlet 120 is preferably a V-shaped weir or large pipe with sufficient capacity to release the desired amount of tank water 132 without requiring extensive free board of the casing 96 or second tank 200.

The use of a V-shaped weir as an outlet 120 is preferred. Such an outlet compensates well for periodic increases in flow of tank water 132 out of the tank created by backwashing. Preferably, a level sensor 140 is provided in the casing 96 or second tank 200 to sense the level of the tank water 132 in direct fluid communication with the outlet 120. The level sensor 140 communicates with the controller 142 which preferably incorporates a PLC.

In a first mode of operation, when the level sensor 142 senses that the level of tank water 132 has risen over a selected value, the controller 142 stops the input of feed water 124 which is not restored until the level of the tank water 132 returns to the selected value. The selected value is chosen to reflect the increase in the level of tank water 132 during a backwash event and has the effect of stopping feed during the backwash and for a period after the backwash required to as discharge the backwash water. Thus the level of the tank water 132 is moderated further reducing the need for free board around the outlet and reducing the require capacity of the drain 122.

In a second mode of operation, the amount of backwash water (being permeate) exceeds the flow of tank water 132 out of the tank 100 or second tank 200 required for a desired recovery rate. In this case, based on the level of the tank water 132 as communicated by the sensor 140, the controller 142 stops or slows the flow of feed in advance of a backwash as required to reduce the level of the tank water 132 to a selected value before the backwash, confirmed by the sensor 140. In this case, the selected value is below the outlet 120 as required to ensure that only a required portion of the backwash water exits the tank 100 or second tank 200. In a third mode of operation, this technique of stopping or slowing feed in advance of a backwash is used in conjunction with the first mode of operation above to further moderate fluctuations in the level of the tank water 132. To the extent that these operations create some transience in the flow of tank water 132 through the cassettes 80, such transience is beneficial in reducing dead zones and agitating the membranes 18 provided that the strength of the membranes is not exceeded.

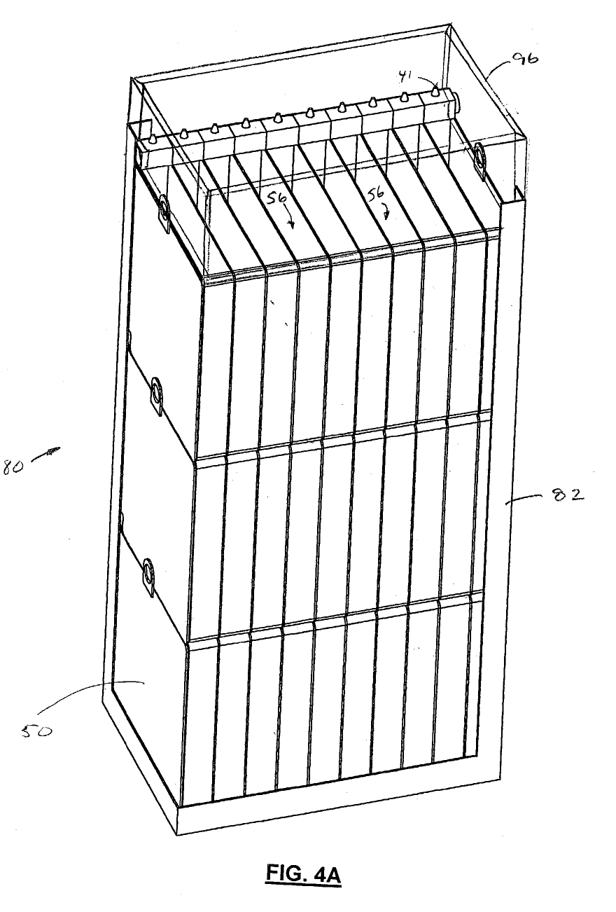

Now referring to FIGS. 5A and 5B, first and second procedures are shown which are used together to potting an element 10. In the first procedure, membranes 28 in sufficient number to produce a potting density of 15-25% (based on the cross-sectional area of the resin 22 normal to the membranes 28) are arranged in a bundle 130 and loosely held by a releasable collar 132. The bundle 130 is produced by winding fibre material on a drum but without purposely arranging the membranes 28 in a grid or matrix. The bundle 130 is dipped quickly in a pool of liquid wax 134, preferably polyethelene glycol such as Carbowax 1400 (a trade mark) produced by Union Carbide, maintained at a temperature slightly above its freezing point. The wax 134 wets the membranes 28 and moves upwards along the membranes 28 by capillary action. Because the temperature of the wax 134 is only slightly above its freezing point, however, the wax 134 freezes within seconds of when the membranes 28 were dipped into it. Thus, the height to which the wax 134 can travel is limited to about 5 to 10 mm. A plug 136 of wax 134 remains at the end of the membranes 28 which seals their ends and holds them in a closely spaced apart relationship. Since this operation is done in the open, the integrity of the plug 136 can be monitored visually.

Referring to the right half of FIG. 5B, in the second procedure an open header 14 is placed with its permeate channels 20 facing upwards. A heater 138 is placed in the permeate channel 20 and covered in wax 134 which is allowed to freeze around it. The heater 138 is electric with wires to a power supply leaving the open header 14 through a permeate opening 32 which is sealed with a temporary end plate (not shown). The bundle 130 is placed in the permeate channel 20, the plug 136 ensuring that all membranes 28 enter the permeate channel 20. The permeate channel 20 is then covered with resin 22 to a depth of 20 to 60 mm above the top of the plug 136. The resin 22 is preferably polyurethane which will wet small diameter membranes 28 by capillary action. Other suitable resins include epoxy, rubberized epoxy and silicone rubber. One or more resins may be applied in one or more coats to meet different objectives of strength, compatibility with the wax 134 and providing a soft interface with the membranes 28 having no cutting edges. After the resin 22 cures, the temporary end plate is removed and the heater 138 is turned on to melt the wax 134 which flows out of the permeate opening 32. The heater 138 is also removed through the permeate opening 32 leaving a clear permeate channel 20 in communication with the lumens of the membranes 28. The collar 132 is removed. A potted bundle 130 is shown in cross section on the left side of FIG. 5B. Other methods of potting the membranes may also be used.

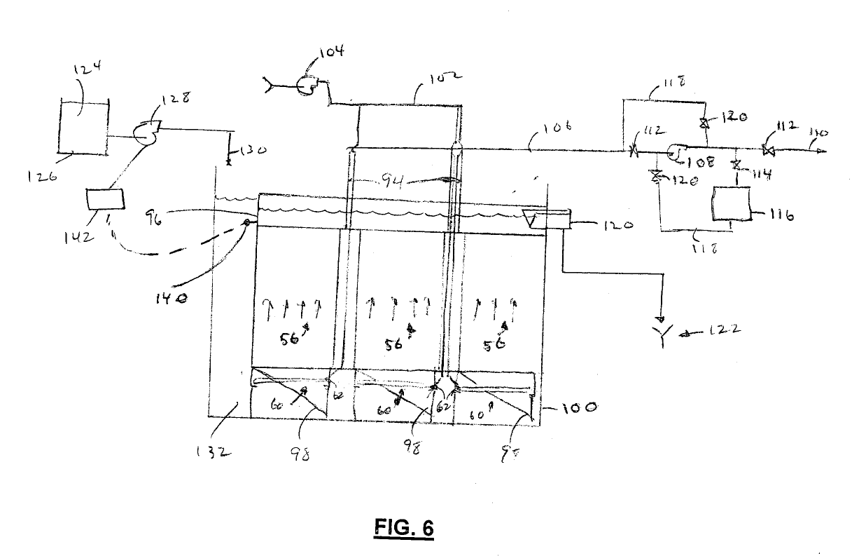

Referring now to FIG. 8, a reactor 1010 is shown for treating a liquid feed having solids to produce a filtered permeate substantially free of solids and a consolidated retentate rich in solids. Such a reactor 1010 has many potential applications such as separating clean water from mixed liquor in a wastewater treatment plant or concentrating fruit juices etc., but will be described below as used for creating potable water from a natural supply of water such as a lake, well, or reservoir. Such a water supply typically contains colloids, suspended solids, bacteria and other particles which must be filtered out and will be collectively referred to as solids.

The first reactor 1010 includes a feed pump 1012 which pumps feed water 1014 to be treated from a water supply 1016 through an inlet 1018 to a tank 1020 where it becomes tank water 1022. Alternatively, a gravity feed may be used with feed pump 1012 replaced by a feed valve. During permeation, the tank water 1022 is maintained at a level which covers a plurality of membranes 1024. Each membrane 1024 has a permeate side which does not contact the tank water 1022 and a retentate side which does contact the tank water 1022. Preferably, the membranes 1024 are hollow fibre membranes for which the outer surface of the membranes 1024 is preferably the retentate side and the lumens 1025 of the membranes 1024 are preferably the permeate side.

Each membrane 1024 is attached to at least one but optionally two headers 1026 such that the ends of the membranes 1024 are surrounded by potting resin to produce a watertight connection between the outside of the membranes 1024 and the headers 1026 while keeping the lumens 1025 of the membranes 1024 in fluid communication with a permeate channel in at least one header 1026. Membranes 1024 and headers 1026 together form of a membrane module 1028. The permeate channels of the headers 1026 are connected to a permeate collector 1030 and a permeate pump 1032 through a permeate valve 1034. When permeate pump 1032 is operated and permeate valve 1034 opened, a negative pressure is created in the lumens 1025 of the membranes 1024 relative to the tank water 1022 surrounding the membranes 1024. The resulting transmembrane pressure is typically between 1 kPa and 150 kPa and more typically between 10 kPa and 70 kPa and draws tank water 1022 (then referred to as permeate 1036) through membranes 1024 while the membranes 1024 reject solids which remain in the tank water 1022. Thus, filtered permeate 1036 is produced for use at a permeate outlet 1038 through an outlet valve 1039. Periodically, a storage tank valve 1064 is opened to admit permeate 1036 to a storage tank 1062. The filtered permeate 1036 may require post treatment before being used as drinking water, but should have acceptable levels of colloids and other suspended solids.

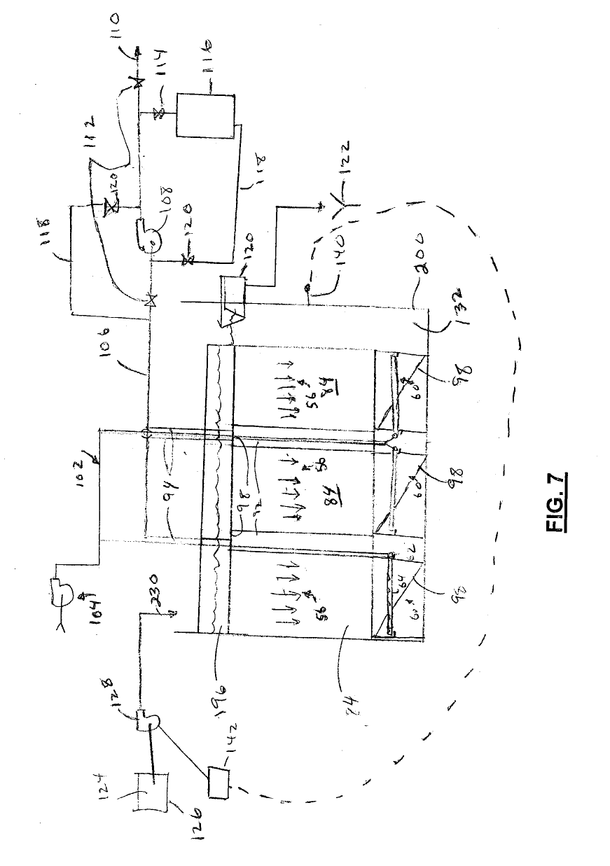

In a municipal or industrial reactor 1010, discrete units each having a plurality of membranes 1024 are assembled together into larger units called membrane modules 1028 which may also be referred to as a cassette. Examples of such membrane modules 1028 are shown in FIGS. 9, 10 and 11 in which the discrete units are rectangular skeins 8. Each rectangular skein 1008 typically has a bunch between 2 cm and 10 cm wide of hollow fibre membranes 1024. The hollow fibre membranes 1024 typically have an outside diameter between 0.4 mm and 4.0 mm and are potted at a packing density between 10% and 40%. The hollow fibre membranes 24 are typically between 400 mm and 1,800 mm long and mounted with between 0.1% and 5% slack. The membranes 1024 have an average pore size in the microfiltration or ultrafiltration range, preferably between 0.003 microns and 10 microns and more preferably between 0.02 microns and 1 micron. The preferred number of membrane modules 1028 varies for different applications depending on factors such as the amount of filtered permeate 1036 required and the condition of the feed water 1014.

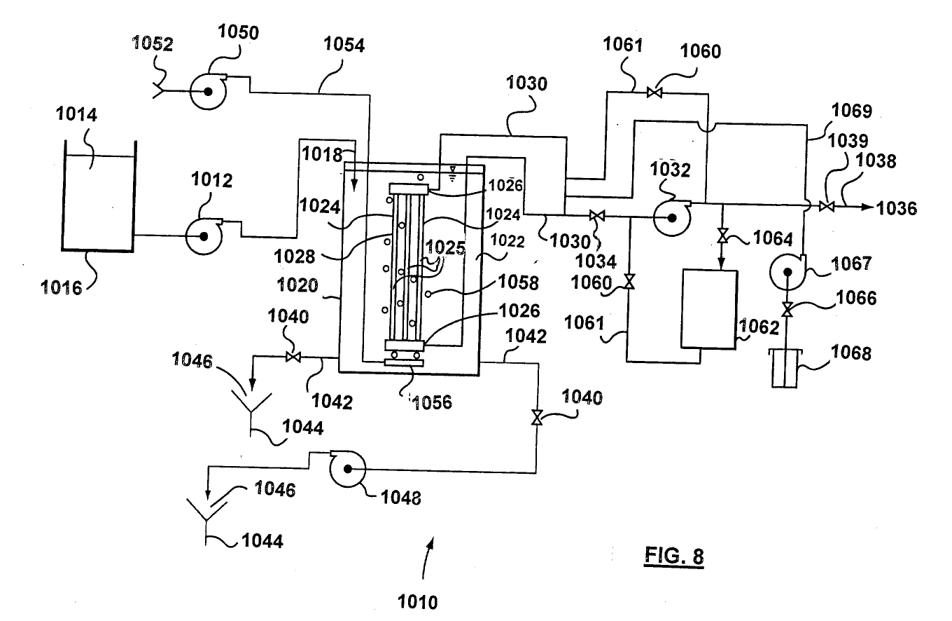

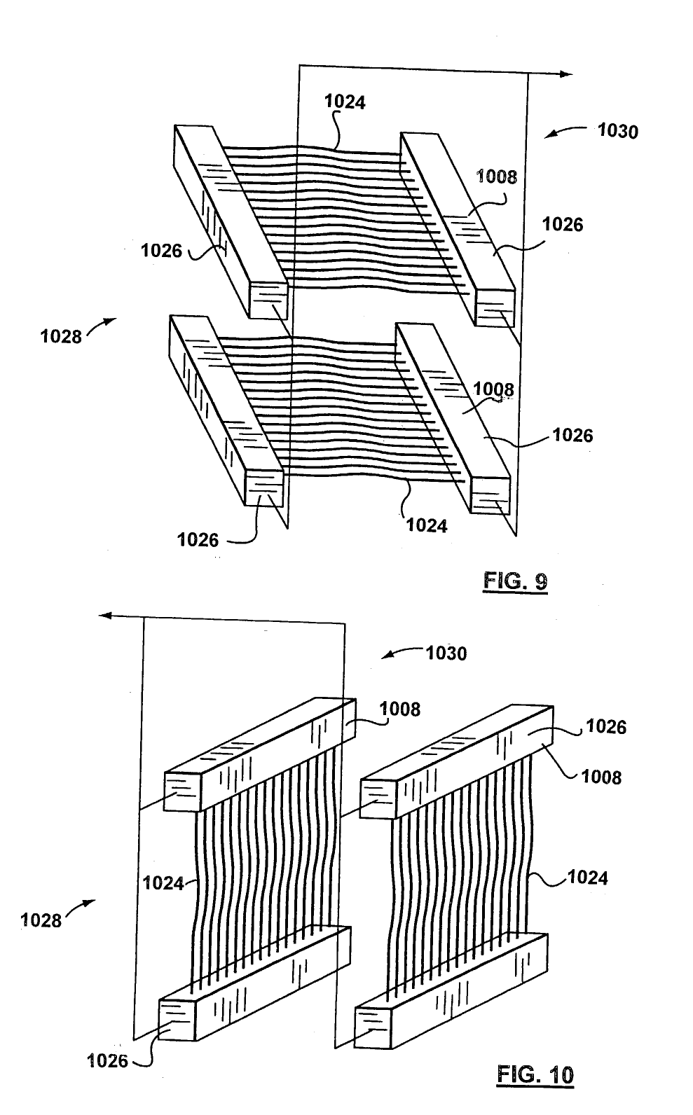

Referring to FIG. 9, for example, a plurality of rectangular skeins 1008 are connected to a common permeate collector 1030. Depending on the length of the membranes 1024 and the depth of the tank 1020, the membrane modules 1028 shown in FIG. 2 may also be stacked one above the other. Referring to FIGS. 10 and 11, the rectangular skeins 1008 are shown in alternate orientations. In FIG. 10, the membranes 1024 are oriented in a horizontal plane and the permeate collector 1030 is attached to a plurality of rectangular skeins 8 stacked one above the other. In FIG. 11, the membranes 1024 are oriented horizontally in a vertical plane. Depending on the depth of the headers 1026 in FIG. 11, the permeate collector 1030 may also be attached to a plurality of these membrane modules 1028 stacked one above the other. The representations of the membrane modules 1028 in FIGS. 9, 10, and 11 have been simplified for clarity, actual membrane modules 1028 typically having rectangular skeins 1008 much closer together and a large cassette often having many more rectangular skeins 1008.

Membrane modules 1028 can be created with skeins of different shapes, particularly cylindrical, and with skeins of looped fibres attached to a single header. Similar modules or cassettes can also be created with tubular membranes in place of the hollow fibre membranes 1024. For flat sheet membranes, pairs of membranes are typically attached to headers or casings that create an enclosed surface between the membranes and allow appropriate piping to be connected to the interior of the enclosed surface. Several of these units can be attached together to form a cassette of flat sheet membranes.

Commercially available membrane modules 1028 include those based on ZW 500 units made by ZENON Environmental Inc. and referred to in the examples further below. Each ZW 500 unit has two rectangular skeins of hollow fibre membranes having a pore size of approximately 0.1 microns oriented as shown in FIG. 10 with a total membrane surface area of approximately 47 square metres. In plan view, each ZW 500 unit is about 700 mm long and about 210 mm wide. Typically, several ZW 500 units are joined together into a cassette to provide a plurality of parallel rectangular skeins 1008. For example, a membrane module 1028 of 8 ZW 500 units is about 1830 mm by 710 mm, some additional space being required for frames, connections and other related apparatus.

Referring again to FIG. 8, tank water 1022 which does not flow out of the tank 1020 through the permeate outlet 1038 flows out of the tank 1020 through a drain valve 1040 and a retentate outlet 1042 to a drain 1044 as retentate 1046 with the assistance of a retentate pump 1048 if necessary. The retentate 1046 is rich in the solids rejected by the membranes 1024.

To provide aeration, an air supply pump 1050 blows ambient air, nitrogen or other suitable gases from an air intake 1052 through air distribution pipes 1054 to aerator 1056 which disperses scouring bubbles 1058. The bubbles 1058 rise through the membrane module 1028 and discourage solids from depositing on the membranes 1024. In addition, where the design of the reactor 1010 allows the tank water 1022 to be entrained in the flow of rising bubbles 1058, the bubbles 1058 also create an air lift effect which in turn circulates the local tank water 1022.

To provide backwashing, permeate valve 1034 and outlet valve 1039 are closed and backwash valves 1060 are opened. Permeate pump 1032 is operated to push filtered permeate 1036 from retentate tank 1062 through backwash pipes 1061 and then in a reverse direction through permeate collectors 1030 and the walls of the membranes 1024 thus pushing away solids. At the end of the backwash, backwash valves 1060 are closed, permeate valve 1034 and outlet valve 1039 are re-opened and pressure tank valve 1064 opened from time to time to re-fill retentate tank 1062.

To provide chemical cleaning, a cleaning chemical such as sodium hypochlorite, sodium hydroxide or citric acid are provided in a chemical tank 1068. Permeate valve 1034, outlet valve 1039 and backwash valves 1060 are all closed while a chemical backwash valve 1066 is opened. A chemical pump 1067 is operated to push the cleaning chemical through a chemical backwash pipe 1069 and then in a reverse direction through permeate collectors 1030 and the walls of the membranes 1024. At the end of the chemical cleaning, chemical pump 1067 is turned off and chemical pump 1066 is closed. Preferably, the chemical cleaning is followed by a permeate backwash to clear the permeate collectors 1030 and membranes 1024 of cleaning chemical before permeation resumes.

Preferably, aeration and backwashing clean the membranes sufficiently so that permeation can continue over extended periods of time. Permeate backwashes typically last for between 5 seconds and two minutes and are typically performed between once every 5 minutes and once every 3 hours. If such permeate backwashes are performed between more intensive restorative cleaning events, the filtering process is still considered continuous since permeation is only stopped momentarily. Similarly, if chemical cleaning is performed in short duration chemical backwashes while the tank 1020 remains full of tank water 1022, the process is still considered continuous. In the cases, however, flow rates of permeate 1036, retentate 1046 and feed water 1014 are calculated as average flow rates over a day or such longer period of time as appropriate. In the description of the embodiments and examples which follow, flow rates of processes that are periodically interrupted as described above are measured as average flow rates unless they are described otherwise.

Referring still to FIG. 8, in rapid flush deconcentration the filtration process proceeds as a number of repeated cycles which end with a procedure to deconcentrate the tank water 1022, the procedure being referred to as a deconcentration. The cycles usually begin at the end of the preceding deconcentration. Some cycles, however, begin when a new reactor 1010 is first put into operation or after intensive restorative cleaning or other maintenance procedures which require the tank 1020 to be emptied. Regardless, the cycle begins with the tank 1020 filled with membranes 1024 submerged in tank water 1022 with an initial concentration of solids similar to that of the feed water 1014.

At the start of a cycle, permeate pump 1032 is turned on and sucks tank water 1022 through the walls of the membranes 1024 which is discharged as filtered permeate 1036. Drain valves 1040 initially remain closed and the concentration of solids in the tank water 1022 rises. While drain valves 1040 are closed, the feed pump 1012 continues to pump feed water 1014 into the tank 1020 at about the same rate that filtered permeate 1036 leaves the tank such that the level of the tank water 1022 is essentially constant during permeation. Aeration and backwashing are provided as required.

After a desired period of time, the tank water 1022 is deconcentrated. The desired period of time between deconcentrations may be based on the concentration of solids in the tank water 1022 but preferably is chosen to achieve a desired recovery rate. For ZW 500 membrane modules used with typical feed water supplies operating with constant aeration and periodic backwashing between deconcentrations, a recovery rate of 95% (ie. 95% of the feed water becomes filtered permeate) or more can be maintained and is preferred when an operator wishes to discharge minimal amounts of consolidated retentate 1046. This recovery rate results in a concentration of solids in the tank water 1022 at the start of the deconcentrations approximately 20 times that of the feed water. However, the inventors have observed in tests performed with continuous membrane filtration processes and feed water having turbidity of 0.5 to 0.6 ntu and apparent colour of 33 Pt. Co. units that the rate at which the permeability of membranes decreases over time rises dramatically when the recovery rate is increased to over 93%. Accordingly, if the volume of wasted retentate is a minor factor, then the period between deconcentrations may be chosen to yield a 90% to 95% recovery rate or less. Typical cycle times when using ZW 500 units range from about 2 to 3 hours at a recovery rate of 90% and 4 to 5 hours at a recovery rate of 95% although cycle times will vary for other membrane modules.

The deconcentrations comprise a rapid flush of the tank water 1022 while maintaining the level of tank water 1022 above the level of the membranes 1024 and continuing permeation. To perform the rapid flush deconcentration, the drain valves 1040 are opened and retentate pump 1048 rapidly draws retentate 1046 rich in solids out of the tank 1020 if gravity flow alone is insufficient. Simultaneously, feed pump 1012 increases the flow rate of feed water 1014 into the tank 1020 by an amount corresponding to the flow rate of retentate 1046 out of the tank 1020. Preferably, the retentate 1046 is removed at a sufficient rate, assisted by retentate pump 1048 if necessary, such that the tank water 1022 is not diluted significantly by mixing with incoming feed water 1014 before it is flushed out of the tank 1020. Some dilution necessarily occurs, and it is preferable to stop the flow of consolidated retentate 1046 while the tank water 1022 still has a concentration of solids greater than the concentration of solids in the feed water 1014 to avoid withdrawing an unacceptably high volume of consolidated retentate 1046. However, the volume of consolidated retentate 1046 withdrawn may exceed the volume of water in the tank 1020. Preferably, aeration and any other source of mixing are turned off to minimize dilution of the retentate 1046 and between 100% to 150% of the average volume of the tank water 1022 is discharged during the rapid flush deconcentration. If aeration must be left on to provide continued cleaning, a higher volume of tank water 1022 is discharged. More preferably, between 100% and 130% of the volume of the average volume of the tank water 1022 is discharged. The total discharge time is typically less than 20 minutes and preferably less than 10 minutes. If there is aeration or other mixing at the time of the rapid flush, then between 150% and 300%, more preferably between 150% and 200%, of the average volume of the tank water 1022 is discharged and the total discharge time is less than 25 minutes. After the deconcentration, the tank water 1022 preferably has less than 40% of the concentration of solids that was present in the tank water 1022 prior to the deconcentration. Where the feed water 1014 has high turbidity or where high recovery rates are used, however, the tank water 1022 after a deconcentration preferably has less than 20% of the concentration of solids that was present in the tank water 1022 prior to the deconcentration. Retentate 1046 is typically disposed of down a drain 1044 to a sewer or to the source of water where it initially came from.

Like a process without deconcentrations, there must still be a balance of solids and water between the feed water 1014, retentate 1046 and filtered permeate 1036 over repeated cycles. Thus for a selected recovery rate, the average amount of solids in the retentate 1046 in a process with deconcentrations will be the same as for a process without deconcentrations. Since the retentate 1046 is typically diluted in rapid flush deconcentrations, however, the tank water 1022 must have a higher concentration of solids immediately before a deconcentration compared to the constant concentration of solids in a fully mixed continuous bleed process. By replacing at least a substantial portion of the existing tank water 1022 with fresh feed water 1014, however, permeation continues in the next cycle with relatively clean tank water 1022 until solids again build up in the tank water 1022 and another deconcentration is performed. Thus the average concentration of solids in the tank water 1022 over time is an intermediate value between that of the feed water 1014 and the consolidated retentate 1046 and less than the constant concentration of solids in a fully mixed continuous bleed process at the same recovery rate. While the tank water 1022 has a lower concentration of solids the membranes foul less rapidly. Accordingly, increased flux of permeate 1036 is observed at a set transmembrane pressure or a higher transmembrane pressure can be used at the beginning of a cycle without excessive fouling of the membranes 1024.

Preferably, a reduced flow rate of air bubbles 1058 is initially supplied to the tank 1020 when the concentration of solids is low and the membranes 1024 foul more slowly. As the concentration of solids rises in the tank water 1022, the flow rate of air is also increased. Alternately, aeration is only provided directly before the deconcentration. In this way, excess air is not supplied while the concentration of solids is low in the tank water 1022. Similarly, the frequency or duration of backwashing may be decreased when the concentration of solids in the tank water 1022 is low to minimize loss in production due to backwashing. To the extent that aeration can be made to coincide with backwashing, the effectiveness of the aeration is increased since is does not have to work against the transmembrane pressure.

Despite the aeration, periodic backwashing, and periodic deconcentrations of the tank water 1022, long term fouling of the membranes may still occur, although more slowly than in a process without deconcentrations. As long term fouling occurs, power to the permeate pump 1032 may be increased to increase the transmembrane pressure across the walls of the membranes 1024 to compensate for the reduced permeability. Eventually, a specified maximum transmembrane pressure for the system or a minimum tolerable permeability of the membranes 1024 will be reached. At this time, intensive restorative cleaning is done. For ZeeWeed (a trade mark) brand membranes 1024, intensive cleaning is preferably done when the transmembrane pressure exceeds 54 kPa or the permeability drops below 200 litres per square metre per hour per bar (L/m²/h/bar) at normal operating temperatures. The tank is typically emptied during the intensive maintenance cleaning, but this is independent of the periodic deconcentrations and occurs only infrequently, between once every two weeks to once every two months.

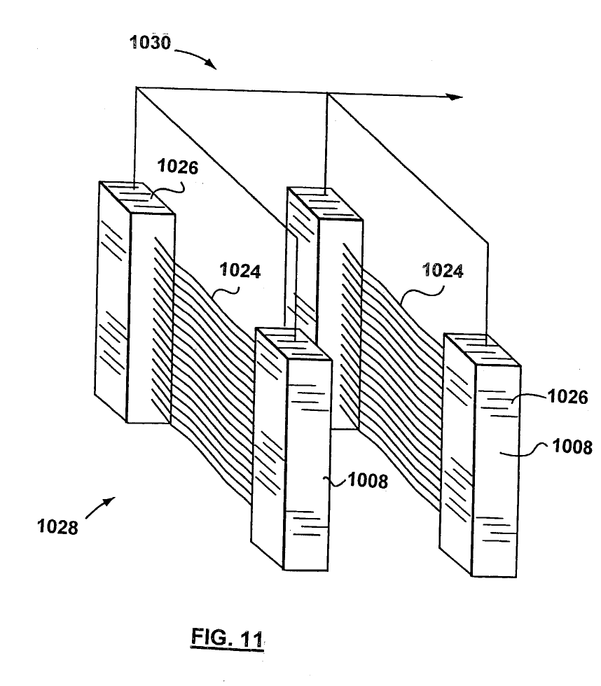

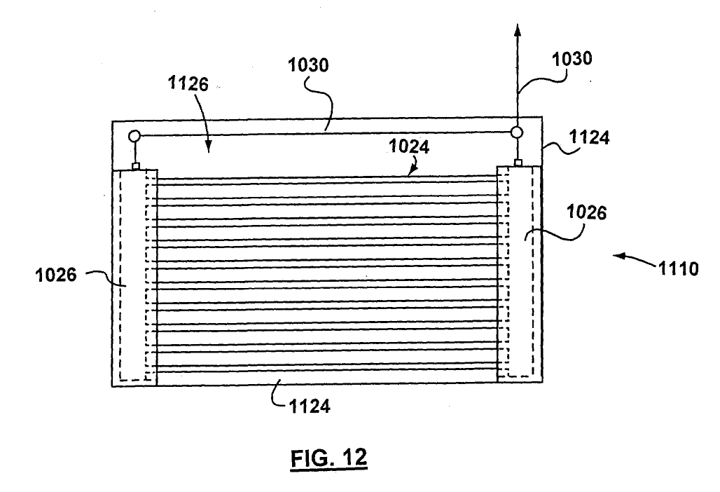

Referring now to FIGS. 12 and 13, another membrane module 1110 having hollow fibre membranes 1024 is shown in elevation and plan view respectively. The membranes module 1110 is similar to that shown in FIG. 11 but the perimeter of the second membrane module 1110 is surrounded by a non-porous casing 1124 which defines a vertically oriented flow channel 1126 through the second membrane module 1110. Similar modules can be created with membrane modules 1028 as shown in FIGS. 9, 10 and 11 or with tubular or flat sheet membranes as described above.

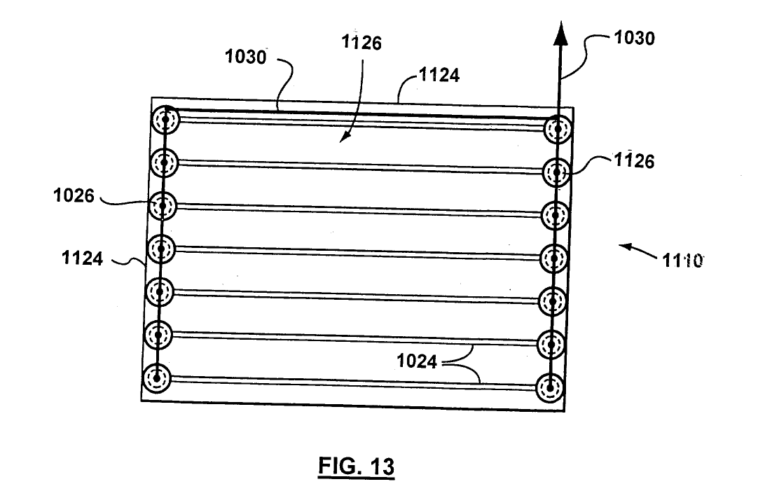

Referring now to FIG. 14, a third reactor 1128 has a plurality of second membrane modules 1110 in a plurality of filtration zones 1130. The third reactor 1128 has a feed pump 1012 which pumps feed water 1014 to be treated from a water supply 1016 through an inlet 1018 to a third tank 1140 where it becomes tank water 1022. During permeation, the feed pump 1012 is operated to keep tank water 1022 at a level which covers the membranes 1024. The permeate collector 1030 of each second membrane module 1110 is connected to a set of pipes and valves as shown including a pair of permeate valves 1144 and a pair of backwash valves 1060. To withdraw permeate from a second membrane module 1110, its associated permeate valves 1144 are opened while its backwash valves 1060 are closed and an associated permeate pump 1032 is turned on. The resulting suction creates a transmembrane pressure (“TMP”) from the outside of the membranes 1024 to their lumens 1025. The membranes 1024 admit a flow of filtered permeate 1036 which is produced for use or further treatment at a permeate outlet 1038. From time to time, a permeate storage valve 1064 is opened to maintain a supply of permeate 1036 in a permeate storage tank 1062. Such an arrangement allows permeate 1036 to be withdrawn from each filtration zone 1130 individually. Preferably, the permeate pumps 1032 are operated to produce a similar flux of permeate 1036 from each filtration zone 1130. Since solids concentration in each filtration zone 1130 differs, as will be explained further below, this typically requires each permeate pump 1032 to be operated at a different speed. Alternatively, the second membrane modules 1110 in different filtration zones 1130 can be connected to a common permeate pump 1032. This will result in some variation in flux between the filtration zones 1130 (because the downstream second membrane modules 1110 are likely to foul faster), but the amount of variation can be minimized by locating the permeate pump 1032 near the outlet 1042 as described above or by variations in aeration, backwashing and packing density to be described below. With any of these techniques, the second membrane modules 1110 can be made to have similar permeate fluxes.

Tank water 1022 which does not flow out of the third tank 1140 through the permeate outlet 1038 flows out of the third tank 1140 through a drain valve 1040 and retentate outlet 1160 to a drain 1044 as consolidated retentate 1046. Additional drains in each filtration zone 1130 (not shown) are also provided to allow the third tank 1140 to be drained completely for testing or maintenance procedures. The consolidated retentate 1046 is rich in the solids rejected by the membranes 1024. Flow of the consolidated retentate 1046 may be assisted by a retentate pump 1048 if required. The inlet 1018 and retentate outlet 1160, however, are separated by the filtration zones 1130. Partitions 1176 at the edges of the filtration zones 1130 force the tank water 1022 to flow sequentially through the filtration zones 1130 in a tank flow pattern 1178. The partitions 1176 have decreasing heights in the direction of the tank flow pattern 1178 such that a difference in depth from one filtration zone 1130 to the next drives the tank flow pattern 1178. The difference in depth between partitions 1176 varies with different applications, but is unlikely to be more than 1 m between the first and last partition 1176. Alternatively, flow from one filtration zone 1130 to the next could be through conduits and driven by differences in depth from one filtration zone 1130 to the next or driven by pumps.

While in normal operation, feed pump 1012 substantially continuously adds feed water 1014 to the third tank 1140 while one or more permeate pumps 1032 substantially continuously withdraw permeate 1036. The process is typically operated to achieve a selected recovery rate defined as the portion of feed water 1014 removed as permeate 1036 (not including permeate 1036 returned to the third tank 1140 during backwashing to be described further below) expressed as a percentage. The selected recovery rates is typically 90% or more and preferably 95% or more.

As the tank water 1022 moves from one filtration zone 1130 to the next, the solids concentration increases as solids lean permeate 1036 is removed. This effect may be illustrated by a simplified example in which the third reactor 1128 shown in FIG. 14 is operated at an overall recovery rate of 95%. 100 flow units of feed water 1014 having a concentration of 1 enters the third tank 1140 at the inlet 1018. According to the recovery rate, 95 flow units leave the third tank 1140 as permeate 1036 while 5 flow units leave the third tank 1140 as consolidated retentate 1046. Assuming equal production from each second membrane module 1110, 19 flow units leave the third tank 1140 as permeate 1036 in each filtration zone. Assuming further (a) that all solids are rejected by the membranes 1024 and (b) that the concentration of solids in a filtration zone 1130 equals the concentration of solids in the flow to the next filtration zone 1130, the following chart is generated by applying a mass balance of fluid and solids to each filtration zone 1130.

| | | | | Flow to | Maximum |
|---|---|---|---|---|---|
| Filtration | Flow | Concentration | Permeate | Next | Concentration |
| Zone | In | in inflow | Flow Out | Zone | in Zone |
| 1 | 100 | 1 | 19 | 81 | 1.2 |
| 2 | 81 | 1.2 | 19 | 62 | 1.6 |
| 3 | 62 | 1.6 | 19 | 43 | 2.3 |
| 4 | 43 | 2.3 | 19 | 24 | 4.2 |
| 5 | 24 | 4.2 | 19 | 5 | 20 |
| | | | | (to | |
| | | | | drain) | |

In comparison, if there were no filtration zones 1130 and the entire third tank 1140 was fully mixed, the tank water 1022 would have a concentration 20 times that of the feed water 1014 throughout. By providing a series of sequential filtration zones 1130 between the inlet 1018 and retentate outlet 1160, the concentration of solids in the tank water 1022 in most of the filtration zones 1130 is significantly reduced. The reduced concentration of solids results in significantly reduced fouling of the second membrane modules 1110 in the applicable filtration zones 1130. Among other benefits, less chemical cleaning is required for these second membrane modules 1110. Further, reduced aeration and backwashing routines are sufficient for individual filtration zone 1130 or groups of filtration zones 1130 with reduced concentrations of solids. Unlike the embodiment above without separate filtration zones 1130, aeration is not required to prevent tank water 1022 from by passing the membrane modules and so less or even no aeration can be provided during substantial periods. Further, by forcing tank water 1022 to flow through the casings 1124, aeration is not required to create local circulation of tank water 1022 around second membrane modules 1110. Accordingly, space in the third tank 1140 is not required for downcomers and the second membrane modules 1110 can occupy 80% or more of the plan area or footprint of the tank 1140.

Aeration is provided, nevertheless, to scour the membranes 1024 which can occur without creating an air lift effect in the tank water 1022. To provide aeration, an air supply 1050 associated with each filtration zone 1130 is operable to blow air, nitrogen or other suitable gases through air distribution pipes 1054 to a header 1170 attached to a plurality of aerators 1056 below the second membrane module 1110. During aeration, the aerators 1056 emit scouring bubbles 1058 below the second membrane module 1110 which rise through the membranes 1024. Thus aeration can be provided to each filtration zone 1130 individually.

The second membrane module 1110 in each filtration zone 1130 can also be backwashed individually by closing its associated permeate valves 1144 and opening its associated backwash valves 1060. The associated permeate pump 1032 (or alternatively, a separate pump) is then operated to draw permeate 1036 from the permeate storage tank 1062 and pump it through the permeate collector 1030 and, ultimately, through the membranes 1024 in reverse direction relative to permeation. Preferably the second membrane modules 1110 in adjacent filtration zones 1130 are not backwashed at the same time. The backwash typically lasts for between 15 seconds and one minute and involves a flux one to three times the permeate flux but in a reverse direction. Accordingly, the level of the tank water 1022 in the backwashed filtration zone 1130 rise temporarily causing more tank water 1022 to flow to the next filtration zone 1130. Preferably, the downstream partition 1176 in each filtration zone is sufficiently lower than the upstream partition 1176 such that tank water 1022 does not flow over an upstream partition 1176 during backwashing.

To achieve a higher density of membranes 1024 in the third tank 1140, the second membrane modules 1110 are sized to nearly fill each filtration zone. Further, the second membrane modules 1110 are positioned such that tank water 1022 or feed water 1014 flowing into a filtration zone 1130 must flow first through the flow channel 1126 of the second membrane module 1110. The tank flow 1178 thus generally flows downwards through each second membrane module 1110 then upwards outside of each second membrane module 1110 and over the downstream partition 1176. Accordingly, the tank flow 1178 is transverse to the membranes 1024 and generally inhibits solids-rich zones of tank water 1022 from forming near the membranes 1024. During backwashing, the tank flow 1178 may temporarily flow upwards through the second membrane module 1110 if the top of the casing 1024 around the second membrane module 1110 is located near the normal level of the tank water 1022. Such reverse flow does not significantly effect the general tank flow 1178 but it is preferred if during backwashing the tank water 1022 does not overflow the second membrane module 1110. In this way, after backwashing stops, there is a momentarily increased tank flow 1178 which assists in moving solids from near the bottom of the second membrane module 1110 to the next filtration zone 1130. For second membrane modules 1110 with minimal aeration, the tank flow through a second membrane module 1110 approaches a plug flow and there is an increase in concentration of solids as the tank water 1022 descends through the second membrane module 1110. Accordingly, membranes 1024 near the top of the second membrane module 1110 experience a concentration of solids even lower than that predicted by the chart above, and comparatively more solids attach to the lower membranes 1024. During aeration, the bubbles 1056 rise upwards against the tank flow 1178 and no space for downcomers is required in the filtration zones 1130.

In another embodiment of the invention, the embodiment described with reference to FIG. 14 is operated in cycles including rapid flush deconcentrations. The resulting temporal reduction in concentration of solids produced by the deconcentrations works to further the effect of the spatial reductions in concentration of solids. With reference to 14, at the start of a cycle, third tank 1140 is filled with tank water 1022. Filtered permeate 1036 is withdrawn from the third tank 1140 while drain valves 1040 remain at least partially and preferably completely closed so that the tank water 1022 becomes more concentrated with solids until a deconcentration is indicated as described above.

Permeation continues while the or third tank 1140 is deconcentrated by simultaneously withdrawing consolidated retentate 1046 from the third tank 1140 and increasing the rate that feed water 1014 enters the third tank 1140 to maintain the level of tank water 1022 above the membranes 1024 during the flushing operation. When the tank water 1022 is deconcentrated by a rapid flush while permeation continues, the volumes of water removed from the third tank 1140 can be the same as those described above. Preferably, however, since only the downstream portion of the third tank 1140 contains tank water 1022 at a high concentration of solids, lower flush volumes may be used since only the downstream part of the tank water 1022 requires deconcentration. With the apparatus of FIG. 14 in which aeration is turned of during the deconcentration, between 20% and 75% of the volume of the tank water 1022 is preferably removed and more preferably between 20% and 50. With the apparatus of FIG. 14, deconcentrations are preferably performed directly after backwashing events so that the increased flux of the tank flow 1178 will entrain more solids.

Deconcentrations can also be performed by stopping permeation and the flow of feed water 1014 into the third tank 1140 while retentate 1046 is withdrawn. The level of the tank water 1022 drops and so the third tank 1140 must first be refilled before permeation can resume. As suggested above, this process avoids dilution of the retentate 1046 with feed water 1014 but also interrupts permeation. In the apparatus of FIG. 14, however, the last filtration zone 1130 can be drained separately while permeation is stopped in that filtration zone 1130 only. Compared to a process in which a tank is emptied, such deconcentrations are performed more frequently but involve less volume each which reduces the capacity of the drain 1044 required. In addition, this technique advantageously allows tank water 1022 rich in solids to be withdrawn while permeating through most membrane modules 1028 and without diluting the retentate 1046. While the flow of feed water 1014 can be stopped completely while the last filtration zone 1130 is emptied, the flow path over the last partition 1176 is preferably fitted with a closure such as a gated weir 1180 or a valved conduit. The closure is shut at the start of the deconcentration which prevents tank water 1022 from flowing over the partition 1176 after the drain valve 1040 is opened. Retentate pump 1048 may be operated to speed the draining if desired. Feed water 1014 continues to be added to the third tank 1140 during the deconcentration until the level of the tank water 1022 rises in the downstream filtration zones 1130 to the point where appreciable reverse flow may occur across the partitions 1176. After the last filtration zone 1130 is emptied, retentate pump 1048 is turned off (if it was on) and drain valve 1040 is closed. The closure is opened releasing an initially rapid flow of tank water 1022 which fills a portion of the last filtration zone 1130. The flow of feed water 1014 is increased until the remainder of the last filtration zone 1130 is filled. To avoid damage to the membranes 1024 during rapid flows of tank water 1022, baffles (not shown) are preferably installed above the second membrane modules 1110 to direct the flow and dissipate its energy.

With the embodiments discussed with reference to FIG. 14, additional advantage is achieved by varying the amount of aeration along the third tank 1140. The connection between the air distribution pipes 1054 and selected aerators 1056 are fitted with restricting orifices or, preferably, each aerator 1056 has a flow control valve associated with it. Second membrane modules 1110 operating in tank water 1022 with low concentration of solids are aerated less forcefully, preferably based on the concentration of solids 1022 in the tank water surrounding each second membrane module 1110. The furthest upstream second membrane module 1110 is exposed to the lowest concentration of solids and thus receives the least amount of air. The most downstream second membrane module 1110 is exposed to the highest concentration of solids and receives the most aeration.

Typically, all aerators 1056 are built to the same design and are rated with the same maximum air flow that can be passed through them. The minimum amount of air flow is typically about one half of the rated maximum air flow, below which the aerator 1056 may fail to aerate evenly. Preferably, the upstream one half or two thirds of the or second membrane modules 1110 are aerated at 50% to 60% of the rated capacity of the aerators 1056 and the remaining second modules 1110 are aerated at 80% to 100% of the rated capacity, the increase being made either linearly or in a step form change. Such a variation approximately follows the increase in solids concentration in the tank water 1022.

Additionally or alternately, tapered backwashing may be employed. Second membrane modules 1110 operating in tank water 1022 with low concentration of solids require less backwashing. The furthest upstream second membrane module 1110 is exposed to the lowest concentration of solids and receives the least amount of backwashing whereas the most downstream or second membrane module 1110 is exposed to the highest concentration of solids and receives the most backwashing. The amount of backwashing is typically increased between these extremes using a lower amount of backwashing for the upstream one half or two thirds of second membrane modules 1110 and then increasing either linearly or in step form to a higher amount for the remaining second membrane modules 1110.

Backwashing can be varied in both frequency or duration. Precise parameters depend on the feed water 1014 and other variables but typically range from a 10 second backwash once an hour to a 30 second backwash once every five minutes, the lower amount being near the former regime and the higher amount being near the latter.

In addition or alternatively, to reduce excessive loss of permeability (because some long term fouling effects are irreversible) and to prevent uneven damage to different membrane module 1028 when tapered aeration is used, the direction of tank flow 1078 may be reversed periodically by providing an inlet 1018 and retentate outlet 1046 at opposite ends of the third tank 1140. Preferably the reversal is done after periodic chemical cleaning which is required approximately every two weeks to two six months and often requires draining the third tank 140. Such flow reversal allows the membranes 1024 near the ends of the third tank 1140 to be operated at times in solids lean tank water 1022 which substantially increases their useful life. Such flow reversal can be accomplished in the embodiment of FIG. 14 with some modification.

In general, second membrane modules 1110 with lower packing density are preferred in solids rich tank water 1022. The reduced packing density allows bubbles 1058 to reach the membranes 1024 more easily and increases the cleaning or fouling inhibiting effect of aeration. For solids lean tank water 1022, higher packing density is desirable as more membrane surface area is provided for a given volume of second tank 1120 or third tank 1140. Alternatively or additionally, the packing density of downstream second membrane modules 1110 is reduced relative to upstream second membrane modules 1110 with a corresponding change in the size of the filtration zones 1130. Preferred upstream packing densities vary from 20% to 30%. Preferred downstream packing densities vary from 10% to 20%.

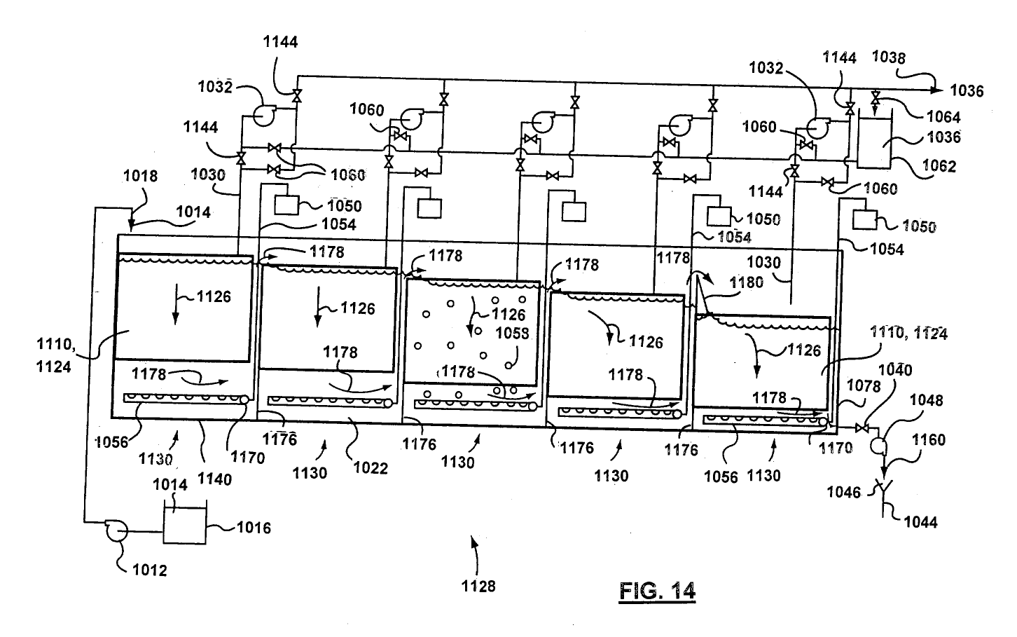

Referring to FIG. 15, a round tank 1220 is used. Inlet 1018 is located at one point on the circumference of the tank 1220 and the retentate outlet 1042 is located in the middle of the tank 1220, or alternately (as shown in dashed lines) at another point on the circumference of the tank 1220. Second membrane modules 1110 are placed in a ring around the centre of the tank 1220 in a horizontally spaced apart relationship. An internal divider 1222 in the tank 1220 is used to create a circular flow path 1276 between the inlet 1018 and the retentate outlet 1042.

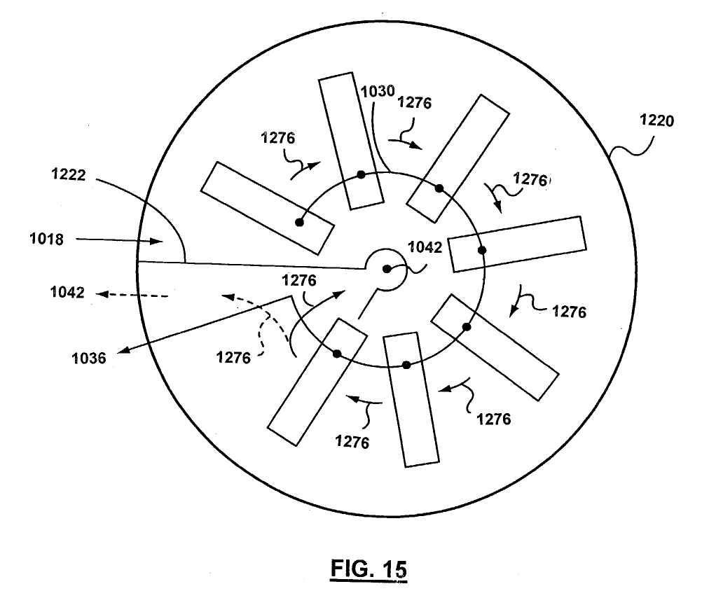

Referring to FIG. 16, a low aspect ratio or square tank 1320 is used. Inlet 1018 is located at one point on the tank 1320 and the retentate outlet 1042 is located at another point on the tank 1320. An internal divider 1322 in the tank 1320 is used to create a flow path 1376 between the inlet 1018 and the retentate outlet 1042. Second membrane modules 1110 are placed in series along the flow path 1376 in a horizontally spaced apart relationship. Alternately, in a variation shown in dashed lines, the internal divider 1322 is a wall between separate tanks joined in series by fluid connector 1324.

Where the round tank 1220 or low aspect ratio or square tank 1320 is used in place of the third tank 1128, partitions 1176 are provided between second membrane modules 1110.

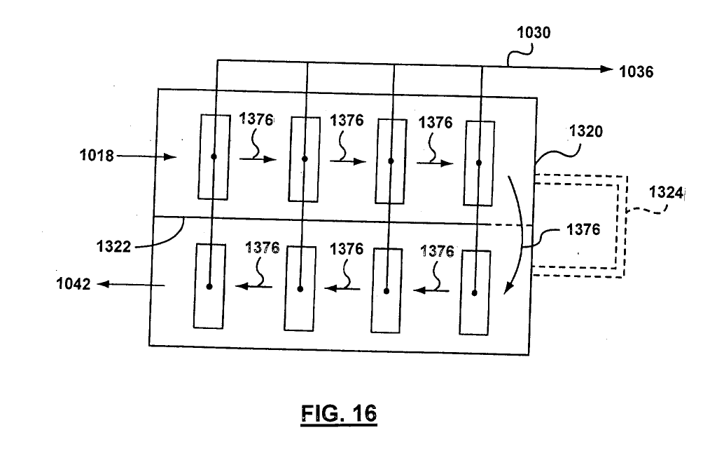

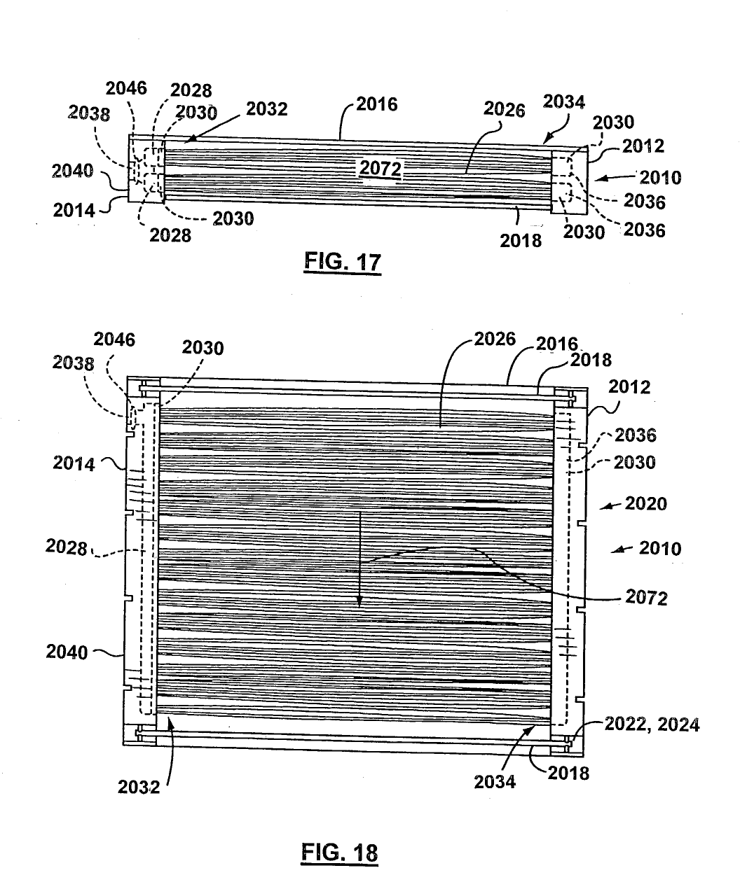

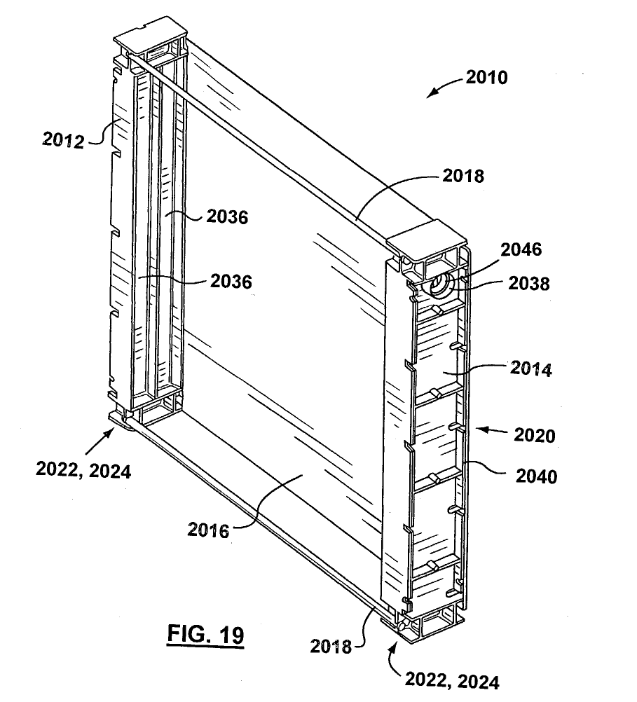

Referring now to FIGS. 17, 18 and 19, a filtering element 2010 is shown in various views. The element 2010 has a vertically extending closed header 2012 and a vertically extending open header 2014. The closed header 2012 and open header 2014 are held in an opposed horizontally spaced relationship by one or more side plates 2016 or struts 2018 extending between the closed header 2012 and open header 2014. Preferably, the closed header 2012 and open header 2014 are rectangular solids (but for cavities etc.) and the side plates 2016 are attached to the closed header 2012 and open header 2014 by snap fittings 2020, although screws, glue or other appropriate fasteners may be used. The struts 2018 are preferably cylindrical with grooved ends 2022 which snap into recesses 2024 in the closed header 2012 and open header 2014.

When an element 2010 is used alone, two side plates 2016 are used, one on each side of the closed header 2012 and open header 2014. Alternately, a plurality of elements 2010 can be placed side by side in a row, as will be described further below. In that case a combination of a side plate 2016 on one side of the element 2010 and one or more struts 2018 on the other side of the element 2010 is used, as illustrated, except for the last element 2010 in the row which has two side plates 2016. In this way, a single side plate 2016 between two elements 2010 serves both such elements 2010. Side plates 2016, open headers 2012 and closed headers 2014 define vertical flow channels 2072 through elements 2010.

A plurality of hollow fibre membranes 2026 are attached to and suspended between the closed header 2012 and the open header 2014. The membranes 2026 have at least one open end 2032 each. The open ends 2032 of the membranes 2026 are held in a closely spaced apart relationship in a plug of potting resin 2030 which encloses one or more permeate channels 2028 of the open header 2014. The resin 2030 surrounds each open end 2032 of the membrane 2026 so that water cannot enter the permeate channel 2028 other than by passing through the walls of the membranes 2026. The interior of the membranes 2026 are in fluid communication with the one or more permeate channels 2028 so that permeate withdrawn through the membranes 2026 can be collected in the one or more permeate channels 2028. Suitable potting techniques are known in the art. Another suitable technique is described in the applicants Canadian Patent Application No. 2,290,053. Suitable resins 2030 include polyurethane, epoxy, rubberized epoxy and silicone resin. One or more resins 2030 may also be used in combination to meet objectives of strength and providing a soft interface with the membranes 2026 having no cutting edges.

The membranes 2026 have a pore size in the microfiltration or ultrafiltration range, preferably between 0.003 and 10 microns and more preferably between 0.01 and 1.0 microns. The membranes 2026 may each be a distinct fibre having only a single open end 2032 each, but preferably the membranes 2026 are made of looped fibres having open ends 2032 in fluid communication with a permeate channel 2028 of the open header 2014 and looped ends 2034 connected to the closed header 2012. The membranes 2026 are unsupported internally (i.e. by a substrate) or externally (i.e. by transverse fibres) and can be made, for example, of cellulose acetate, polypropylene, polyethylene, polysulfone and preferably of a complex of PVDF and calcined .alpha.-alumina particles as described in U.S. Pat. No. 5,914,039. In order to produce a large surface area, the membranes 2026 preferably have small outside diameters in the range of 0.2 mm to 1.0 mm. With such small diameter membranes 2026, head loss in the lumen of the membranes 2026 is significant and preferred effective lengths of fibre are short—between 0.2 m for smaller diameter fibres to 1.0 m for larger fibres. The effective length is defined as the maximum distance between an un-potted point on the membranes 2026 and the proximal face of the open header 2014 and, accordingly, each loop of a membrane 2026 is approximately twice the effective length plus length required for potting.

With membranes 2026 as described above, the tensile strength of the membranes 2026 is low and the forces applied to the membranes 2026 by aeration are a concern. By arranging the membranes 2026 as loops with their looped ends 2034 attached to the closed header 2012, the unsupported length of the membranes, and thus the forces on the membranes 2026 from aeration, are reduced in half compared to the usual configuration wherein horizontal membranes are suspended between two permeating headers. The membranes 2026 do not need to be sealingly secured to the closed header 2012 but are preferably fixedly attached so that tensile forces in the membranes 2026 are transferred to the closed header 2012. As an example, membranes 2026 made of complex of PVDF and calcined alpha. alumina particles, as mentioned above, with an outside diameter of 0.6 mm and an inside diameter of 0.35 mm are suitable for an element 2010 in which the proximal faces of the closed header 2012 and the open header 2014 are spaced less than 0.7 m apart, preferably between 610 and 615 mm apart.

The membranes 2026 are mounted such that the un-potted length of the membranes 2026 is between 0.1% and 5% greater than the distance between the closed header 2012 and the open header 2014. This slackness of the membranes 2026 allows them to vibrate under the influence of scouring bubbles which aids in inhibiting their fouling. Additionally, the membranes 2026 may be slanted slightly upwards towards the open header 2014 at about 5 degrees as measured along a line from their looped ends 2034 to their open ends 2032. The angle of the membranes 2026 assists in withdrawing air from the looped ends 2034 of the membranes 2026 when a new module is first used after manufacture or some maintenance procedures. In many cases, however, air in the lumens of the membranes 2026 leaves the membranes 2026 shortly after a transmembrane force is applied to the membranes 2026. In these cases, the membranes 2026 are preferably mounted substantially horizontally rather than slanted.

The open header 2014 and closed header 2012 are injection moulded or machined from a suitable plastic such as PE, PP, polyester or polycarbonate. The closed header 2012 and open header 2014 are less than 1 m in length which is more convenient for injection moulding and allows various numbers of elements 2010 to be stacked on top of each other to more completely fill tanks of varying depths. The open header 2014 preferably has permeate channels 2028 each between 30 mm and 40 mm wide. The closed header 2012 has corresponding potting cavities 2036 of similar width. A bundle of membranes 2026 between 20 and 30 mm wide is potted between each permeate channel 2028 and its corresponding potting cavity 2036. Adjacent bundles of membranes are spaced about 5 mm and 20 mm apart. The width and spacing of the bundles helps water and air bubbles to penetrate the bundle while still providing a large surface area of membranes 2026, preferably over 500 m² of surface area for each cubic metre of volume of the element 2010.

As an example, a suitable element 2010 has a closed header 2012 and open header 2014 that are about 700 mm long and 100 mm wide. Each closed header 2012 and open header 2014 has two permeate channels 2028 and potting cavities 2036, respectively, about 35 mm wide and about 600 mm long. The element 2010 is provided with approximately 31 000 membranes 26 of 0.6 mm outside diameter and between 610 and 615 mm in length arranged in two bundles about 25 mm wide for a total surface area of approximately 36 m² or more than 700 m² of surface area for each cubic metre of volume of the element 2010. At a flux of 30 L/m²/h, for example, the element 2010 produces about 1.1 m³/h of permeate.

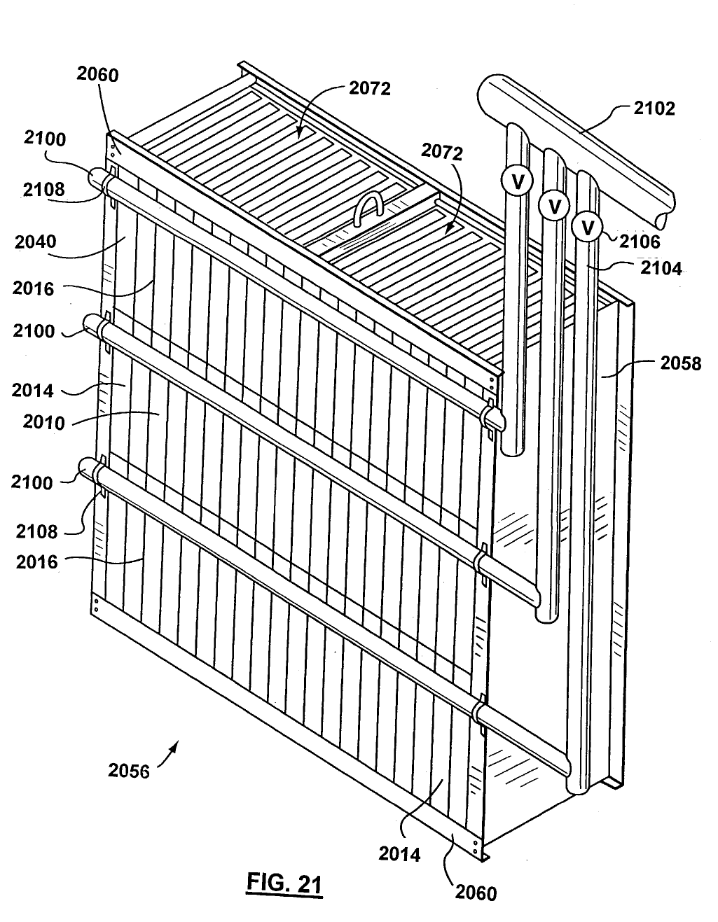

In FIG. 21, a module 2056 having several elements 2010 is shown from where the backs 2040 of the elements 2010 are visible. The elements 2010 are placed side by side in rows such that the side plates 2016, closed headers 2012 and open headers 2014 form a plurality of directly adjacent vertical flow channels. A module 2056 can have a single row of elements 2010 or multiple rows such that the elements 2010 are arranged in a vertical orthogonal grid as illustrated. In such a grid, the side plates 2016, closed headers 2012 and open headers 2014 of the elements 2010 form a plurality of directly adjacent vertical flow channels 2072 that extend through the module 2056. The module 2056 illustrated has three rows of twenty elements 2010 each but the number and arrangement of elements 2010 shown gives an example only. Modules 2056 may be constructed in a large range of heights and widths to best fit a given tank. The exterior of the module 2056 is constructed of two solid side walls 2058 held in place by rails 2060 sized to accommodate a desired number and arrangement of elements 2010. A handle 2062 at the top of the module 2056 allows the module 2056 to be lifted or lowered.

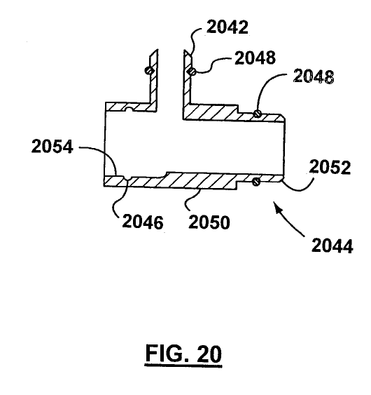

Now referring to FIGS. 17 through 20, a permeate opening 2038 (of about 25 mm in diameter for the element 2010 described above) connects an upper end of the permeate channels 2028 to the back 2040 of the open header 2014 of an element 2010. The permeate opening 2038 is adapted to receive a permeate tap 2042 of a permeate fitting 2042 shown in FIG. 20. The permeate opening has one or more grooves 2046 sized to fit one or more O-rings 2048 on the permeate tap 2042. The O-ring(s) 2048 and groove(s) 2046 create a releasable and resealable water tight seal between the element 2010 and a permeate fitting 2044.

Now referring to FIGS. 20 and 21, the permeate fitting 2044 also has a body 2050 (of about 50 mm in outside diameter for the element 2010 described above) having a male part 2052 and a female part 2054. The body 2050 corresponds in length to the spacing between adjacent elements 2010. The male part 2052 fits into the female part 2054 of an adjacent permeate fitting 2044 with a releasable water tight seal provided by O-rings 2048. In this way, the permeate fittings 2054 of multiple elements 2010 placed side form a continuous permeate collector 2100. Alternatively, adjacent permeate fittings 2044 can be attached to each other by gluing or ultrasonically welding them to produce a permeate collector 2100 or a single pipe can be fitted with the required number and spacing of permeate taps 2042. Straps 2108 hold the permeate collectors 2100 in position relative to the module 2056.

The permeate collectors 2100 are attached to a permeate trunk 2102 through intermediate pipes 2104 and valves 2106. The permeate collectors 2100 can be arranged in numerous ways. In one arrangement, each permeate collector 2100 is associated only with elements 2010 in a single horizontal row of the orthogonal grid of the module 2056. Valves 2106 associated with the permeate collectors 2100 are arranged to allow a gas for bubble point integrity testing of the elements 2010 to flow only to elements 2010 in a single horizontal row of the orthogonal grid. The integrity of the elements 2010 of a module 2056 can be tested by flowing a gas at a selected pressure, calculable as known in the art, into the lumens of the membranes 2026 in the module 2056. The arrangement of valves 2106 and permeate collectors 2100 described above allows an operator to flow the gas at selected times only to elements 2010 in a single horizontal row of the orthogonal grid. The presence of bubbles in a vertical flow channel 2072 indicates a defect in the element 2010 in that column of the orthogonal grid and in the row receiving the gas. Once located, a defective element 2010 is replaced with a new element 2010 allowing permeation to resume while the defective element 2010 is repaired.

In an alternate arrangement, not illustrated, vertical permeate collectors are attached in fluid communication with a small number, preferably three, elements 2010 in each of the rows of a module 2056. This arrangement allows smaller pipes (typically 25 mm in diameter) for permeate collectors and removes the need for intermediate pipes 2104 thus occupying less of the footprint of a tank. This arrangement also reduces the effect of pressure drop in a horizontal permeate collector 2100 which can limit the maximum number of elements 2010 that can be placed side by side in a module 2056. To perform an integrity test with this arrangement, the gas is flowed into the lumens of the membranes 2026 but at a plurality of selected pressures. The selected pressures are substantially equal to the bubble point of a defect of interest plus the static head of each row of elements 2010 in the module 2056. Preferably, the selected pressures are applied to the lumens of the membranes 2026 sequentially from the lowest pressure to the highest pressure. While not as certain as the first integrity testing method, the pressure at which bubbles appear suggests the row in which a defect exists without the need for valves 2106. Once located, a defective element 2010 is replaced with a new element 2010 allowing permeation to resume while the defective element 2010 is repaired.

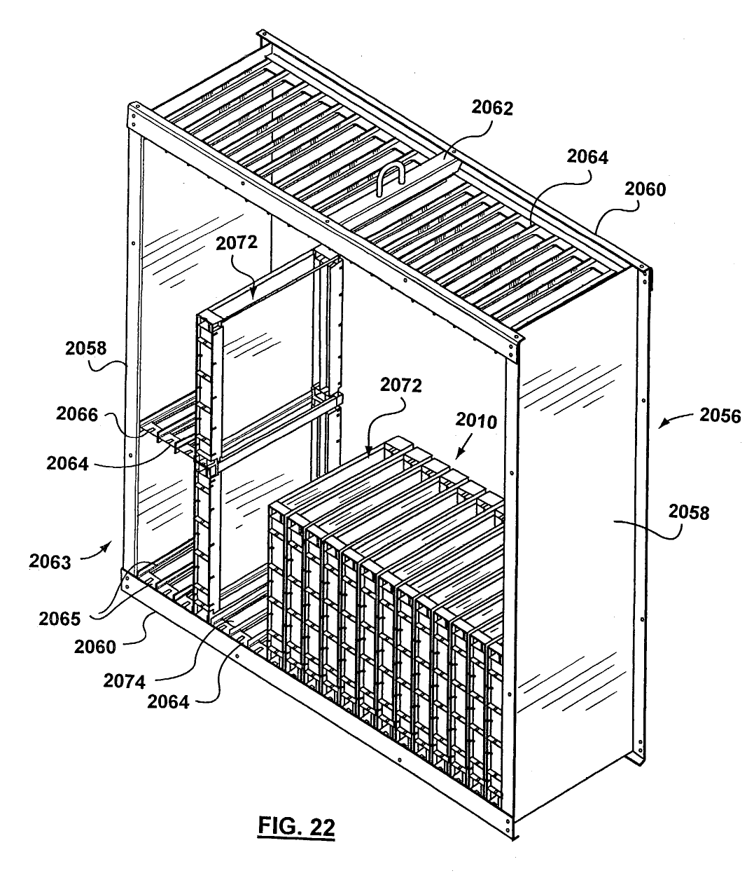

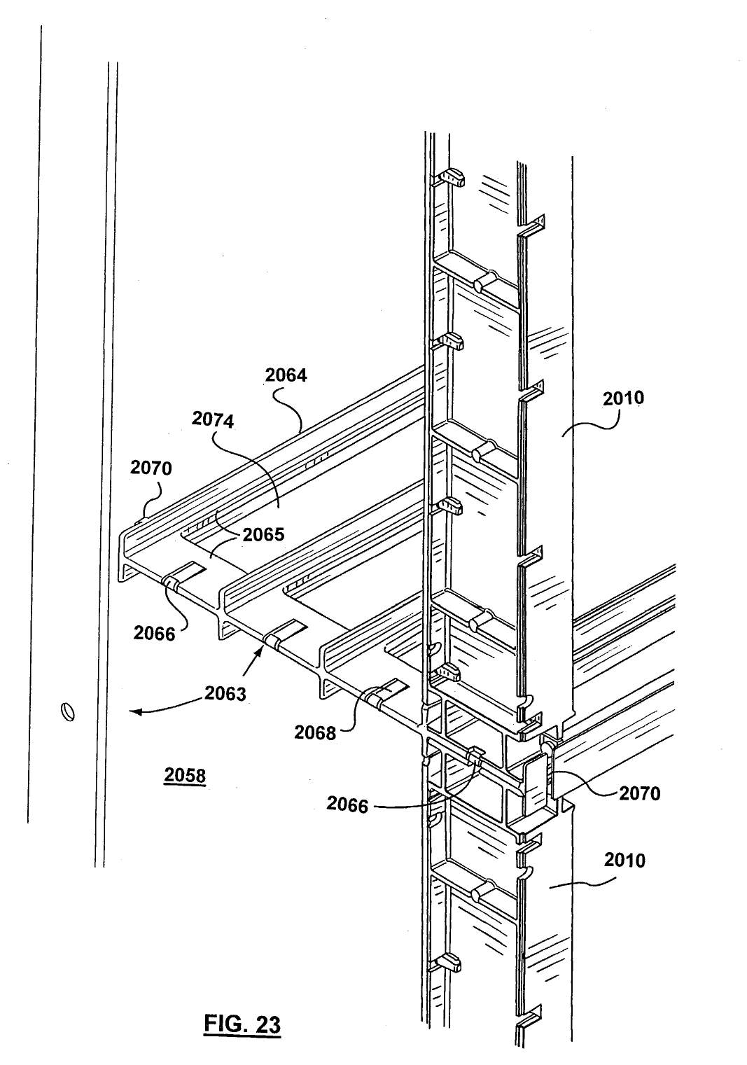

Referring to FIGS. 22 and 23, the front of the module 2056 is shown in greater detail but many elements 2010 are not shown so that the assembly of the module 2056 can be illustrated. Within the module 2056, elements 2010 are held in place by a frame 2063 comprising the side walls 2058, rails 2060 and racks 2064. The frame 2063 restrains the elements 2010 in place but does not obstruct the vertical flow channels 2072. Further, the restraint provided by the frame 2063 can be released for a selected element 2010 in a direction substantially normal to the headers of the selected element 2010 or the grid, the direction in the module 2056 illustrated being a horizontal direction. The selected element 2010 may be removed from the module 2056 when such restraint is released without disassembling the remainder of the module 2056. In the module 2056 illustrated, an element 2010 is removed by pulling it forward out of its row. When an element 2010 is removed from the module 2056, the movement in the horizontal direction releases the seal between the element 2010 and the permeate collector 2100. When the element 2010 is replaced, the movement in a reverse direction reseals the element 2010 to the permeate collector 2100.

The ability to releasably restrain elements 2010 is provided in the module 2056 illustrated by means of the racks 2064. Each rack 2064 has a bearing surface 2065 to slidably support an element 2010. The bearing surface 2065 is oriented in the direction substantially normal to the open header 2012 of the element 2010, the direction in which the element 2010 moves when it is removed from the module 2056. Similarly, the racks 2064 are sized to allow an element 2010 to slide in the direction substantially normal to the open header 2012 into the space between an upper rack 2064 and a lower rack 2064. The racks 2064 are preferably symmetrical so that the same rack 2064 can accept an element 2010 above the rack 2064, below the rack 2064 or both. The rear of each rack 2064 is provided with a stop (not illustrated) which engages the back 2040 of an element 2010. The front of each rack has a releasable catch 2066 which engages the front of elements 2010 above and below it to secure the elements 2010 in the rack 2064. The catch 2066 has a recess 2068 which allows it to be flexed upwards or downwards to release an element 2010.

Several racks 2064 can be attached side by side to form a line of racks 2064 extending between the side walls 2058 of a module 2056. The racks 2064 can be attached by moulding them together in convenient numbers, such as four as illustrated, and attaching these mouldings to adjacent mouldings by fasteners or dovetail joints 2070. Preferably, each racks 2064 is rigidly attached to at least one adjacent rack 2064. To assemble a module 2056, a first line of racks 2064 is placed between the lower rails 2060, the lower rails 2060 being adapted to hold the racks 2064 so that a sufficient amount of the racks 2064 project above the rails 2060. A first row of elements 2010 is than placed on the first line of racks 2064 followed by subsequent rows of elements 2010 and racks 2064. When an upper row of elements 2010 is ready to be installed, an upper line of racks 2064 is held temporarily in place between the upper rails 2060 until enough elements 2010 have been slid into position. Once all elements 2010 and racks 2064 are installed, any element 2010 can be removed from the module 2056 by moving the appropriate catches 2066 and sliding the element 2010 forward. Provided that an excessive number of elements 2010 are not removed at one time, the remaining racks 2064 and elements 2010 remain stable.

As mentioned above, the permeate fittings 2044 are inserted into the permeate opening 2038 of each element 2010 and joined to adjacent permeate fittings 2044 to create a continuous permeate collector 2100. This continuous collector 2100 is fixedly attached to the module 2056 such that removing an element 2010 from the module 2056 causes it to detach from its associated permeate fitting 2044. The permeate fitting 2044 remains attached to the module 2056 so that a replacement element 2010 can be inserted into the module 2056 and engage the permeate fitting 2044. Maintenance or repair procedures can thus be accomplished by lifting the module 2056 from a tank, pulling out an element 2010 to be maintained or repaired, replacing it with a spare element 2010 and replacing the module 2056 in its tank.

Referring to FIG. 22, when the elements 2010 are attached side-by-side and stacked one on top of the other, the side plates 2016 of adjacent elements 2010 define vertical flow channels 2072 through the module 2056 containing the membranes 2026. If the side walls 2058 are not solid, the last element 2010 has an additional side plate 2016 to define a flow channel 2072 in it. The racks 2064 have corresponding openings 2074 which allow the flow channels 2072 to be in fluid communication with tank water outside of the module 2056. The width of the flow channels 2072, in combination with the slackness of the membranes 2026, is such that the membranes 2026 move sideways enough to substantially fill a central portion of the flow channels 2072, the central portion preferably being between a third and two thirds of the distance between the proximal faces of the open header 2014 and closed header 2012. The reduced length of the membranes 2026, compared to a design in which permeate is withdrawn from both ends of the membranes 2026, tends to reduce tangling of the membranes 2026 and reduces the width of the flow channel 2016 allowing more compact elements 2010. The side plates 2016 also protect the membranes 2026 from damage during shipping, installation or maintenance and temporary side plates 2016 are used as necessary when elements 2010 are handled.

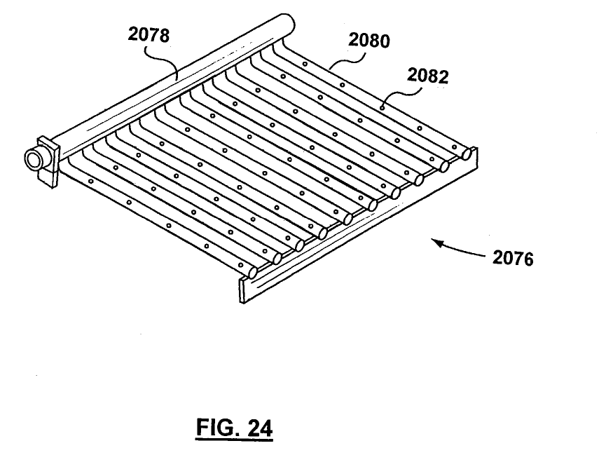

Referring now to FIG. 24, a sub-module aerator 2076 is shown having a header 2078 connected to a series of parallel conduit aerators 2080 having holes 2082 to produce air bubbles. The spacing between the conduit aerators 2080 is preferably the same as the width of the elements 2010. Alternately, the conduit aerators 80 can be placed perpendicular to the elements 2010 and the holes 2082 spaced apart by the width of the elements 2010. In either way, the sub-module aerator 2076 can be installed to provide a source of air holes 2082 directly below the flow channel 2072 of each element 2010. Such an arrangement promotes a controlled amount of aeration being provided to each element 2010 and minimizes air flow channelling which can starve membranes 2010 of air, particularly when aeration rates are low. If required, a conduit aerator 2080, or a hole 2082 in a conduit aerator 2080 perpendicular to the elements 2010, can be provided directly below the side plate 2016 between each pair of elements 2010 to similar effect, although the first arrangement described is preferred.

In use, one or more elements 2010 or modules 2056 are placed in a tank of water to be filtered such that the membranes 2026 are immersed in the water to be filtered. The design of the elements 2010 and modules 2056 allows a large surface area of membranes 2026 to be placed in a tank. For example, in a conventional filtering reactor, using aeration to both agitate the membranes 2026 and to generate an airlift to circulate water to be filtered, about 50% of the tank area is covered with modules 2056. Such modules 2056 can provide over 400 m² of surface area of membranes 2026 for each m of footprint or horizontal cross-sectional area of a tank.

Rather than using this large surface area to generate a large yield, however, a preferred process uses a low or moderate flux of less than 50 L/m²/h and preferably less than 35 L/m²/h. Such a flux provides yields comparable to sand filtration. For example, modules 2056 covering 50% of the footprint of a tank can produce a superficial tank velocity of over 10 m/h at a flux of 25 to 30 L/m²/h. Compared to a more typical flux of 50 to 75 L/m²/h, the reduced flux results in significantly reduced fouling of the membranes 2026.

In combination with a low or moderate flux, a preferred process includes periodically stopping permeation. Other process steps are performed during periods of time when permeation is periodically stopped. The other process steps include backwashing the modules 2056 from time to time, aerating the modules 56 to scrub or inhibit fouling of the membranes 2026 from time to time, and emptying and refilling the tank from time to time to remove accumulated solids. Such a process requires surprisingly little aeration to maintain adequate permeability of the membranes 2026. In particular, aerating the modules 2056 to scrub the membranes 2026 during periods of time when permeation is periodically stopped is done at a superficial velocity (m³/h of air at standard conditions per m² of module cross-sectional area) of 80 m/h to 340 m/h, depending on feed water quality.

Aeration to scrub or inhibit fouling of the membranes 2026 preferably occurs during periods of time when permeation is stopped because during these periods the aeration does not need to overcome suction on the membranes 2026 to dislodge solids from the membranes 2026. For many if not most feed waters, aeration to inhibit fouling is not required at other times. During permeation, however, the concentration of solids in the water to be filtered can increase within the modules 2056. For some feed waters, typically having high turbidity and solids concentrations more than about 500 mg/L, a smaller amount of aeration is advantageously provided during permeation to disperse solids from the modules 2056, particularly from any dead zones in the modules 2056, or to generally homogenize the contents of the tank. For this purpose, aeration is provided during permeation intermittently at a superficial velocity of 80 m/h to 340 m/h or continuously at a rate less than 80 m/h.

Surprisingly, the energy cost savings produced by operating at low flux and low aeration significantly offsets the cost of providing a large surface area of membranes 2026 in the form of the elements 2010 and second modules 2056 described above. The inventors believe that the design of the modules 2056, for example the horizontal orientation of the membranes 2026, the distribution of membranes 2026 in the flow channels 2072 and the flow of tank water through the flow channels 2072, assists in reducing the amount of aeration required and allows the invention to be competitive with sand filtration for filtering potable water.

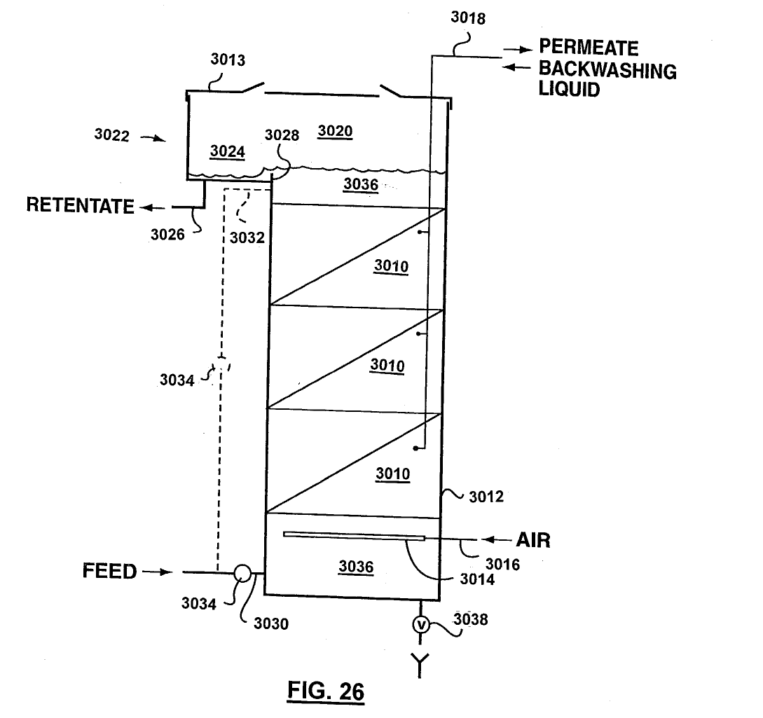

Referring to FIG. 26, three membrane modules 3010 are stacked on top of each other in a tank 3012. The tank 3012 is open to the atmosphere although it may be covered with a vented lid 3013. The membrane modules 3010 may contain flat sheet or hollow fibre membranes with pore sizes in the microfiltration or ultrafiltration range, preferably between 0.003 and 10 microns and more preferably between 0.01 and 1.0 microns. An inner surface of the membranes is connected to one or more headers. An aerator 3014 is mounted below the membrane modules 3010. The aerator 3014 is connected to an air supply pipe 3014 in turn connected to a supply of air, nitrogen or other suitable gas. The membrane modules 3010 include, within their horizontal cross-sectional area, channels for water and air bubbles to flow vertically through the membrane modules 3010 to agitate or scour the membranes. When membrane modules 3010 are stacked on top of each other, they are aligned such that water can flow vertically through the stack.

Preferably, the membrane modules 3010 contain hollow fibre membranes oriented horizontally and mounted in a slightly slackened state between pairs of horizontally spaced, vertically extending headers. One example is formed of several elements placed side-by-side, each element having a large number of fibres of between 0.2 and 1.0 mm outside diameter and between 0.2 m and 1.0 m in length (the shorter length used for the smaller diameter fibres and the longer length used for larger diameter fibres) potted at either end in a header but with permeate withdrawn from only one header. The elements may be separated by impervious vertical plates. Such modules can provide 500 to 1500 m² of membrane surface area for each m² of horizontal cross-sectional area of a large municipal or commercial tank and there is minimal channeling or dead zones when tank water flows through the modules.

The membrane modules 3010 are sized and positioned to fill most of the horizontal cross-sectional area of the tank 3012 leaving room only for necessary fittings and other apparatus and maintenance or set-up procedures. Space is not provided for downcomers outside the perimeter of the modules 3010 and baffles are provided if necessary to block flow through any space left for fittings etc. or otherwise outside the perimeter of the membrane modules 3010. Preferably more than 90%, more preferably substantially all, of the horizontal cross-sectional area of the tank 3012 is filled with membrane modules 3010.

A permeate pipe 3018 connects the headers of the membrane modules 3010 to means for permeating by suction on the inner surfaces of the membranes and backwashing means. Such means are known in the art and allow the permeate pipe 3018 to be used to either withdraw permeate from the tank 3012 or to flow a backwashing liquid (typically permeate or permeate mixed with a chemical) in a reverse direction through the membranes and into the tank 3012 in which the backwashing liquid becomes part of tank water 3036.

An upper portion 3020 of the tank 3012 is provided with a retentate outlet 3022 having an overflow area 3024 connected to a drain pipe 3026 to remove retentate from the tank 3012. Retentate outlet 3022 preferably incorporates an overflow or weir 3028 which helps foam produced by aeration (otherwise a cleanliness, safety or volatile chemical release problem) to flow into the overflow area 3024. The retentate outlet 3022 preferably also has sufficient capacity to release expected flows of retentate quickly to reduce the required free board of the tank 3012.

Feed water enters the tank 3012 through a first inlet 3030 or a second inlet 3032 as determined by feed valves 3034. Once in the tank 3012, feed water may be called tank water 3036 which flows generally upwards or downwards through the membrane modules 3010.

A filtration cycle has a permeation step followed by a deconcentration step and is repeated many times between more intensive maintenance or recovery cleaning procedures. The permeation step typically lasts for about 15 to 60 minutes, preferably 20 to 40 minutes and is carried out in the absence of aeration. Permeate flux is preferably between 10 and 60 L/m²/h, more preferably between 20 and 40 L/m²/h, wherein the surface area of hollow fibre membranes is based on the outside diameter of the membranes.

During permeation, feed water is added to the tank 3012 from one of the inlets 3030, 3032 at substantially the rate at which permeate is withdrawn. Tank water 3036 flows through the membrane modules 3010 to generally replace permeate as it is withdrawn from the tank 3012. Thus during permeation little if any tank water 3036 flows out of the retentate outlet 3022 and the level of the tank water 3036 remains above the membranes. If the membrane module 3010 acts to some extent like a media filter (as will some membrane modules 3010 of tightly packed horizontally oriented hollow fibre membranes), feed preferably enters the tank 3012 through the second inlet 3032. In this way, solids in some feed waters are preferentially deposited in the upper membrane module 3010, closer to the retentate outlet 3022 and where the upward velocity of the tank water 3036 during a deconcentration step will be the greatest, as will be explained below. This set up is also useful in retrofitting sand filters which are typically set up to receive feed from the top and to backwash from below. For other membrane modules 3010, installations or feed waters, the first inlet 3030 may be used during permeation.

The deconcentration step commences when permeation stops and lasts for about 20 to 90 seconds, preferably 30 to 60 seconds. During the deconcentration step, scouring bubbles are produced at the aerator 3014 and rise through the membrane modules 3010. In addition one or both of the steps of backwashing and feed flushing are performed. To flush with feed water, feed enters the tank 3012 through the first inlet 3030 creating an excess of tank water 3036 which rises upwards through the membrane modules 3010. The rate of flow of feed water during feed flushing is typically between 0.5 and 2, preferably between 0.7 and 1.5, times the rate of flow of feed water during permeation. With either backwashing or feed flushing, the level of the tank water 3036 rises, tank water 3036 flows upwards through the membrane modules 3010 and tank water 3036 containing solids (then called retentate) flows out of the retentate outlet 3022 to deconcentrate the tank water 3036.

In some cases, the upwards velocity of the tank water 3036 may create forces on the membranes that exceed their strength, particularly if strong feed flushing and back washing are performed simultaneously. In these cases, the rate of flow of feed water or backwash liquid or both can be reduced to reduce the upward velocity of the tank water 3036. Alternatively, the flow of feed water can be turned off during backwashing and any feed flushing done while there is no backwashing and vice versa. For example, a deconcentration step may involve backwashing preferably with aeration but without feed flushing for a first part of the deconcentration step and feed flushing preferably with aeration but without backwashing for a second part of the deconcentration step. Further alternatively, deconcentration steps involving backwashing preferably with aeration but without feed flushing can be performed in some cycles and deconcentration steps involving feed flushing preferably with aeration but without backwashing can be used in other cycles. Other combinations of the above procedures might also be used.

Aeration is typically performed at the same time as the other steps to reduce the total time of the deconcentration step. Aeration may, however, begin several seconds (approximately the time required for a bubble to rise from the aerator 3014 to the surface of the tank water 3036) before backwashing or feed flushing. Such aeration in the absence of tank water 3036 flow (because no space was left for downcomers) causes turbulence which help loosen some foulants and float some solids to near the top of the tank 3012 before retentate starts flowing out the retentate outlet 3020.

Aeration during the deconcentration step does not need to overcome suction to dislodge solids from the membranes and is provided at a superficial velocity (m³/h of air at standard conditions per m² of module cross-sectional area) between 25 m/h and 75 m/h. For many if not most feed waters, particularly those feed waters having low turbidity and solids concentrations less than about 500 mg/L, additional aeration is not required. Nevertheless, a smaller amount of aeration may be provided with difficult feed water during permeation to disperse solids from dead zones in a membrane module 3010 and homogenize the tank water 3036. For this purpose, aeration is provided at a superficial velocity less than 25 m/h or intermittently at the higher rates described above.

During the deconcentration step, the feed water or backwashing liquid introduced into the tank 3012 creates a flow of tank water 3036 upwards through the modules 3010. The tank water 3036 flowing through the membrane modules 3010 helps remove solids loosened by the scouring bubbles from the membrane modules 3010 and also directly acts on the surface of the membranes. The tank water 3036 flows most rapidly near the top of the tank 3012 which helps reduce preferential fouling of upper membranes when membrane modules 3010 are stacked, for example to depths of 2 m or more. Some solids in the tank water 3036 may have a settling velocity greater than the velocity of the upflow velocity and will settle. The volume of these solids is small and they may be removed from time to time by partially draining the tank 3012 through a supplemental drain 3038.

Based on a design permeate flux, the required flow of feed water during permeation can be calculated and delivered, typically by adjusting a feed pump or feed valve. The frequency and intensity of deconcentration events is then selected to achieve a desired loss in membrane permeability over time. If flux during permeation is kept below about 60 μm²/h, preferably less than 40 L/m²/h, the inventors have found that surprising little fouling occurs and the periodic deconcentration events are usually sufficient. More surprisingly, the energy cost savings produced by operating at low flux and low aeration more than offsets the cost of filling the tank 3012 with membrane modules 3010. Despite the low flux (compared to a more typical flux of 50 to 100 L/m²/h), high tank velocities (flux of permeate in m³/h divided by tank horizontal cross sectional area in m²) are achieved which compare favourably with sand filtration. Further, resulting recovery rates are generally adequate for single stage filtration and are typically adequate for the first stage of two stage filtration (wherein the retentate is re-filtered) even with aggressive deconcentration.

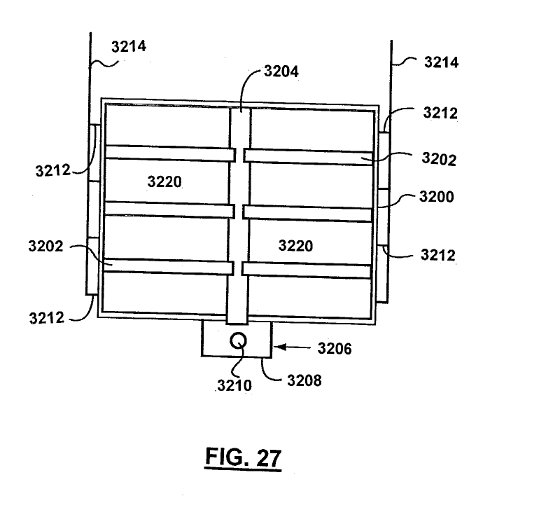

FIG. 27 shows a plan view of a larger filtering reactor. A second tank 3200 encloses several cassettes 3220 each of which may contain a plurality of membrane modules. Open channels 3202 are provided between adjacent cassettes 3220 to receive tank water overflowing the cassettes 3210 as described above. The channels 3202 are sloped to drain towards a larger trough 3204 which is in turn sloped to drain towards a second outlet 3206. The second outlet 3206 has an outlet box 3208 to temporarily hold the discharged tank water before it flows into a drain pipe 3210. As in the embodiment of FIG. 26, feed water enters the second tank 3200 at a point below the cassettes 3220, but several second inlets 3212 are attached to an inlet header 3214 to provide a distributed supply of feed.

It is to be understood that what has been described are preferred embodiments of the invention for example and without limitation to the combination of features necessary for carrying the invention into effect. Various features of the embodiments above may also be combined to create further embodiments. The invention may be susceptible to certain changes and alternative embodiments without departing from the subject invention, the scope of which is defined in the following claims.

We claim:

1. In a process for filtering water containing solids using filtering membranes in an open tank including the steps of:
(a) introducing a feed water containing an initial concentration of solids into the tank to immerse the membranes in water containing solids;
(b) treating the water in the tank by contacting it with a first side of the membranes under the influence of a transmembrane pressure towards a second side of the membranes to produce a filtered permeate with a reduced concentration of solids on a second side of the membranes, the reduced concentration of solids being less than the initial concentration of solids;
(c) removing the permeate produced on the second side of the membranes from the tank; and,
(d) introducing feed water into the tank to replace the permeate removed from the tank to keep the membranes immersed in water while permeate is withdrawn from the tank, the improvement comprising;
(i) reducing the concentration of solids in the water in the tank from time to time through deconcentrations including the steps of withdrawing a retentate having an increased concentration of solids compared to the initial concentration of solids from the tank and replacing it with a similar volume of feed water; and,
(ii) keeping the membranes immersed in water during the deconcentrations by adding feed water to the tank while retentate is withdrawn from the tank. delete
wherein the time between deconcentrations is selected to produce a desired amount of permeate, the desired amount of permeate being a percentage of the amount of feed water entering the tank;
the percentage is 90% or greater; and
the membranes are aerated continuously or intermittently at least during steps b(i) and the flow rate of air of the aeration is increased towards a later part of the steps b(i).

2. The process of claim 1 wherein the membranes are aerated only directly before step b(ii).

3. A filter for treating water containing solids to produce a permeate lean in solids comprising:
(a) an open tank defining a generally horizontal flow path between an inlet to supply a feed water containing solids into the tank and an outlet for water rich in solids to leave the tank;
(b) six or more membrane modules of filtering membranes placed in the tank spaced horizontally consecutively along the flow path, such that (i) any distance between adjacent membrane modules along the flow path is less than one half of the length of a membrane module measured along the flow path, (ii) the total length of all of the membrane modules measured along the flow path excluding any distance between them along the flow path is at least twice the width of the membrane modules measured perpendicular to the flow path and (iii) the distance from the membrane one or more modules to the walls of the tank measured perpendicular to the flow path is greater than any distance along the flow path between adjacent membrane modules;
(c) permeate collectors for connecting a permeate side of the filtering membranes to a source of negative pressure; and,
(d) agitators below the modules operable when the tank is filled with water containing solids to entrain water containing solids around the membrane modules and flow the water containing solids upwards through the modules substantially throughout permeation;
wherein the total length of all of the membrane modules measured along the flow path excluding any space along the flow path between them is at least four times the width of the membrane modules.

4. The invention of claim 3 wherein filtering membranes in a first membrane module have a packing density that is greater than a packing density of filtering membranes in a second membrane module located closer to the outlet than the first module.

5. A module of filtering hollow fibre membranes comprising,
a plurality of the elements each having
(i) a pair of opposed horizontally spaced, vertically extending headers,
(ii) a side plate extending between the pair of vertically extending headers on a side of the pair of vertically extending headers,
(iii) a plurality of hollow fibre membranes attached to and suspended between the pair of vertically extending headers, the hollow fibre membranes, (I) having each at least one open end (II) having each an outer surface, the outer surfaces of the open ends of the hollow fibre membranes connected to at least one header with a water impermeable connection and,
(iv) one or more permeate channels in at least one of the headers in fluid communication with the interior of the hollow fibre membranes for collecting a permeate drawn through the hollow fibre membranes,
wherein the elements are arranged in a vertical orthogonal grid and the side plates and headers of the elements form a plurality of directly adjacent vertical flow channels extending through the module; and,
wherein the module has a plurality of permeate collectors wherein each permeate collector is associated only with elements in a single horizontal row of the orthogonal grid and having a valves associated with the permeate collectors arranged to allow a gas for bubble point integrity testing of the elements to flow only to elements in a single horizontal row of the orthogonal grid.

6. A method of testing the integrity of the elements of a module of claim 5 comprising the steps of flowing a gas at a selected pressure into the lumens of the membranes in the module but at selected times flowing the gas only to elements in a single horizontal row of the orthogonal grid.

7. A method of testing the integrity of the elements of a module of claim 5 comprising the steps of flowing a gas at a plurality of selected pressures into the lumens of the membranes in the module wherein the selected pressures are substantially the bubble point of a defect of interest plus the static head of each row of elements in the module.

8. A process of filtering water comprising the steps of,
(a) proving one or more modules of filtering hollow fibre membranes;
(b) arranging the one or more membrane modules in an open tank to cover substantially all of the horizontal cross sectional area of the tank;
(c) providing an outlet from the tank above the one or more modules;
(d) adding feed water to the tank from below the modules;
(e) withdrawing a filtered permeate through the modules
(f) periodically stopping permeation to backwash and aerate the modules; and,
(g) discharging retained solids through the outlet.

9. The process of claim 8 wherein the filtering membranes are oriented horizontally.

10. The process of claim 8 wherein the membranes have vertical flow channels through them.

11. In an apparatus for filtering water having:
(a) an open tank;
(b) one or more filtering membranes within the open tank;
(c) a source of suction on the one or more membranes to withdraw a filtered permeate through the one or more membranes;
(d) a backwash apparatus for backwashing the membranes from time to time with filtered permeate; and,
(e) an inlet for feed water to enter the tank, the improvement comprising,
(i) a controller for controlling the rate of flow of feed water through the inlet;
(ii) an outlet from the tank; and,
(iii) a sensor to indicate the level of any water in the tank in direct fluid communication with the outlet,
wherein,
(iv) the sensor is connected to the controller to provide a signal to the controller indicating the level of any water in the tank in direct fluid communication with the outlet; and,
(v) the controller is adapted to adjust the rate of flow of feed water in response to the signal.

12. The apparatus of claim 11 wherein the outlet incorporates a weir.

13. A process for filtering water comprising the steps of:
(a) providing an apparatus as described in claim 11;
(b) maintaining a level of water in the tank so as to immerse the membranes while filtered permeate is withdrawn through the membranes;
(c) stopping the flow of feed water while the level of water in the tank exceeds a selected value, the selected value being above the membranes, above the outlet, and below the top of the tank.

14. The process of claim 13 including stopping the flow of feed water in advance of a backwashes to moderate fluctuations in the level of water in the tank.

15. A process for filtering water comprising the steps of:
(a) providing an apparatus as described in claim 11;
(b) maintaining a level of water in the tank so as to immerse the membranes while filtered permeate is withdrawn through the membranes;
(c) stopping the flow of feed water in advance of backwashes as required to reduce the level of water in the tank to a selected value before the backwash begins, the selected value being chosen so that the backwash causes an amount of water to flow out of the tank which gives a desired recovery rate.

16. A filtering reactor comprising:
a) an open tank;
b) a plurality of filtering membranes occupying substantially all of the horizontal cross-sectional area of the tank, to withdraw a filtered permeate;
c) an inlet to add feed to the tank from below the membranes; and,
d) an outlet to discharge water from the tank containing retained solids.

17. The reactor of claim 16 wherein the outlet incorporates a weir.

18. A process for filtering water comprising the steps of,
a) providing a filtering reactor comprising,
i) a tank open to the atmosphere;
ii) one or more modules of suction driven filtering membranes in the tank for withdrawing a filtered permeate;
iii) an inlet to add feed water to the tank; and,
iv) retentate outlet to discharge water containing retained solids from the tank from above the one or more modules;
wherein
v) the one or more modules may be backwashed with a liquid comprising permeate;
vi) the one or more modules have a surface area of at least 500 square meters for every square meter of horizontal cross-sectional area of the tank;
vii) the one or more modules cover more than 90% of the horizontal cross-sectional area of the tank;
viii) the one or more modules are divided into elements, each element having a pair of opposed headers;
ix) the elements are separated from each other by impervious plates; and,
x) channels are provided for water to flow vertically through the elements;
b) in repeated cycles,
(i) permeating filtered water while adding a sufficient volume of feed water to the tank to keep the membranes submerged; and
(ii) performing a deconcentration step further comprising at least one or both of (A) providing a flow of feed water into the tank from below the modules or (B) backwashing the one or more membrane modules with a liquid comprising permeate, wherein excess water containing retained solids flows out of the retentate outlet.

19. The process of claim 18 wherein the step of permeating is performed at a flux of less than 60 Liters per square meter per hour based on the surface area of the outside of the filtering membranes.

20. The process of claim 19 wherein the step of permeating is performed at a flux of less than 40 Liters per square meter per hour based on the surface area of the outside of the filtering membranes.

21. The process of claim 18 wherein permeation is stopped during the deconcentration step and the one or more modules are aerated while permeation is stopped during the deconcentration step.

22. The process of claim 21 wherein the step of permeating is performed at a flux of less than 60 Liters per square meter per hour based on the surface area of the outside of the filtering membranes.

23. The process of claim 22 wherein the step of permeating is performed at a flux of less than 40 Liters per square meter per hour based on the surface area of the outside of the filtering membranes.
